(19) United States
(12) Patent Application Publication
(10) Pub. No.: US 2026/0168725 A1
(43) Pub. Date: Jun. 18, 2026

(54) REFRIGERATOR

(71) Applicant: SAMSUNG ELECTRONICS CO., LTD., Suwon-si, Gyeonggi-do (KR)

(72) Inventors: Suhyeong LIM, Suwon-si (KR); Donghyeon KWAK, Suwon-si (KR); Jaejin LEE, Suwon-si (KR); Hojune JEON, Suwon-si (KR)

(73) Assignee: SAMSUNG ELECTRONICS CO., LTD., Suwon-si, Gyeonggi-do (KR)

(21) Appl. No.: 19/529,770

(22) Filed: Feb. 4, 2026

Related U.S. Application Data
(63) Continuation of application No. PCT/KR2024/009118, filed on Jun. 28, 2024.

(30) Foreign Application Priority Data
Aug. 30, 2023 (KR) 10-2023-0114981
Nov. 3, 2023 (KR) 10-2023-0151229
Jan. 17, 2024 (KR) 10-2024-0007696

(51) Int. Cl. F25D 23/02; E05F 15/616

(52) U.S. Cl. CPC F25D 23/028; E05F 15/616; E05Y 2201/11; E05Y 2900/31; F25D 2323/02

(57) ABSTRACT

A refrigerator comprises: a main body forming a storage compartment; a door provided to open/close the storage compartment; and a door opening device, mountable to the main body, to open the door. The door opening device comprises: a moving rod movable with respect to the main body between a first position and a second position; and a push roller, coupleable to one side of the moving rod, to be rotatable with respect to the moving rod while being coupled to the one side of the moving rod, the push roller being rotated with respect to the moving rod while pressing the door as the moving rod moves from the first position toward the second position along a direction in which the door is opened.

### CROSS-REFERENCE TO RELATED APPLICATION

This application is a continuation application, under 35 U.S.C. § 111(a), of international application No. PCT/KR 2024/009118, filed Jun. 28, 2024, which claims priority under 35 U.S.C. § 119 to Korean Patent Application Nos. 10-2023-0114981, filed Aug. 30, 2023, 10-2023-0151229, filed Nov. 3, 2023, 10-2024-0007696, filed Jan. 17, 2024, the disclosures of which are incorporated herein by reference in their entireties.

### TECHNICAL FIELD

The disclosure relates to a refrigerator.

### BACKGROUND ART

A refrigerator is a device that is composed of a main body including a storage compartment, and a cold air supply system configured to supply cold air to the storage compartment so as to keep food fresh. The storage compartment includes a refrigerating compartment in which food is kept refrigerated by maintaining the temperature at approximately 0 to 5 degrees Celsius, and a freezing compartment in which food is kept frozen by maintaining the temperature at approximately −30 to 0 degrees Celsius. A front surface of the storage compartment is provided to be open for food entry and exit.

The refrigerator uses a compressor, a condenser, an expander, and an evaporator to repeat a cooling cycle of compressing, condensing, expanding, and evaporating a refrigerant. In this case, both the freezing compartment and the refrigerating compartment may be cooled by a single evaporator disposed on the freezing compartment, or the freezing compartment and the refrigerating compartment may each be provided with the evaporator, thereby being cooled independently of each other.

The refrigerator includes a door that opens and closes the storage compartment. The door is rotatable relative to the main body so as to open and close the storage compartment.

The door may be provided to allow a user to hold a handle disposed on the door, and thus the user can open and close the door relative to the main body by rotating the door. Alternatively, the refrigerator may include a door opening and closing structure configured to easily open or close the door.

### DISCLOSURE

### Technical Problem

The disclosure is directed to providing a refrigerator including an improved structure to allow a door to be opened automatically.

The disclosure is directed to providing a refrigerator including an improved structure to allow a door to be easily opened.

The disclosure is directed to providing a refrigerator including an improved structure that prevents wear from occurring between a door pusher or a counterpart pressed by the door pusher or prevents damage to components, when a door opening device opens a door

The disclosure is directed to providing a refrigerator including an improved structure that prevents foreign substances from entering components such as a door opening device of the refrigerator.

The technical objectives of the present invention are not limited to the above, and other objectives that are not described above will be clearly understood by those skilled in the art from the above detailed description.

### Technical Solution

According to an embodiment of the disclosure, a refrigerator may include: a main body forming a storage compartment, a door configured to open and close the storage compartment, and a door opening device mountable on the main body and configured to open the door. The door opening device may include a moving rod configured to be movable relative to the main body between a first position and a second position, and a push roller coupleable to one side of the moving rod so as to be rotatable relative to the moving rod while being coupled to the one side of the moving rod, the push roller being configured to press the door while being rotated relative to the moving rod as the moving rod moves from the first position toward the second position along a direction in which the door is opened.

According to an embodiment of the disclosure, a refrigerator may include a main body forming a storage compartment, a door configured to open and close the storage compartment, and a door opening device mounted on the main body and configured to open the door. The main body may include an accommodating space configured to accommodate the door opening device, and an opening provided at one side of the accommodating space. The door opening device may include a drive motor, a moving rod configured to receive power from the drive motor and be withdrawn from the accommodating space through the opening or be inserted into the accommodating space through the opening, and a push roller coupleable to one side of the moving rod so as to be rotatable relative to the moving rod while being coupled to the one side of the moving rod, the push roller being configured to press the door and rotate relative to the moving rod as the moving rod moves in a direction in which the moving rod is withdrawn from the accommodating space.

According to an embodiment of the disclosure, a refrigerator may include a main body forming a storage compartment, a door configured to open and close the storage compartment and having an accommodating space formed therein and an opening at one side of the accommodating space, and a door opening device accommodated in the accommodating space and configured to open the door. The door opening device may include a moving lever configured to be movable relative to the accommodating space and be withdrawn from the accommodating space through the opening or be inserted into the accommodating space through the opening, and a push roller coupleable to one side of the moving lever so as to be rotatable relative to the moving lever, the push roller being configured to press the main body and rotate relative to the moving lever as the moving lever moves in a direction to be withdrawn from the accommodating space.

### DESCRIPTION OF DRAWINGS

FIG. 1 is a perspective view of a refrigerator according to one embodiment of the disclosure.

FIG. 2 is a top view illustrating a top table separated from the refrigerator according to one embodiment of the disclosure.

FIG. 3 is a view illustrating the top table and a door opening device of the refrigerator according to one embodiment of the disclosure when a door pusher is located at a first pusher position.

FIG. 4 is a view illustrating the top table and the door opening device of the refrigerator according to one embodiment of the disclosure when the door pusher is located at a second pusher position.

FIG. 5 is a view illustrating a partial configuration of the door opening device of the refrigerator according to one embodiment of the disclosure.

FIG. 6 is a view illustrating a partial configuration of the door opening device of the refrigerator according to one embodiment of the disclosure when the door pusher is at the first pusher position.

FIG. 7 is a cross-sectional view of the door opening device of the refrigerator according to one embodiment of the disclosure when the door pusher is at the first pusher position.

FIG. 8 is a view illustrating a partial configuration of the door opening device of the refrigerator according to one embodiment of the disclosure when the door pusher is at the second pusher position.

FIG. 9 is a cross-sectional view of the door opening device of the refrigerator according to one embodiment of the disclosure when the door pusher is at the second pusher position.

FIG. 10 is an enlarged view illustrating a part of the door pusher included in the door opening device of the refrigerator according to one embodiment of the disclosure.

FIG. 11 is an exploded view illustrating some components of the door pusher included in the door opening device of the refrigerator according to one embodiment of the disclosure.

FIG. 12 is a cross-sectional view illustrating a partial configuration of the refrigerator according to one embodiment of the disclosure.

FIG. 13 is a rear view illustrating a partial configuration of the refrigerator according to one embodiment of the disclosure.

FIG. 14 is a view of the refrigerator according to one embodiment of the disclosure when the door pusher is located at a first pusher position.

FIG. 15 is a view of the refrigerator according to one embodiment of the disclosure when the door pusher is located at a second pusher position.

FIG. 16 is a view illustrating a door and a door opening device of a refrigerator according to one embodiment of the disclosure when a door pusher is located at a first pusher position in.

FIG. 17 is a view illustrating the door and the door opening device of the refrigerator according to one embodiment of the disclosure when the door pusher is located at a second pusher position.

FIG. 18 is a perspective view illustrating the door opening device of the refrigerator according to one embodiment of the disclosure.

FIG. 19 is a bottom view illustrating the door opening device of the refrigerator according to one embodiment of the disclosure.

FIG. 20 is a bottom view illustrating a state in which the door opening device opens the door in the refrigerator according to one embodiment of the disclosure.

FIG. 21 is an exploded view illustrating some components of the refrigerator according to one embodiment of the disclosure.

FIG. 22 is a top view illustrating a state in which the door opening device opens the door in the refrigerator according to one embodiment of the disclosure.

### MODES OF THE DISCLOSURE

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary” or “secondary” may be used simply to distinguish a component from other components, without limiting the component in other aspects (e.g., importance or order).

Further, as used herein, the terms “front,” “rear,” “top,” “bottom,” “side,” “left,” “right,” “top,” “bottom,” and the like are defined with reference to the drawings and are not intended to limit the shape and position of each element.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage room. The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate inside of the storage room from outside of the storage room to maintain inside temperature of the storage room at appropriate temperature without being influenced by an external environment of the storage room. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. The vacuum insulation may further include an adsorbent for adsorbing a gas and water to stably maintain a vacuum state. However, the insulation is not limited to the above-mentioned foaming insulation or vacuum insulation, and may include various materials capable of being used for insulation.

The “storage room” may include a space defined by the inner case. The storage room may further include an inner case defining a space corresponding to a storage room. Various goods, such as food, medicine, cosmetics, etc., may be stored in the storage room, and the storage room may open at least one side to put the goods in or take the goods out.

The refrigerator may include one or more storage rooms. In a case in which two or more storage rooms are formed in the refrigerator, the respective storage rooms may have different purposes of use, and may be maintained at different temperature. To this end, the storage rooms may be partitioned by a partition wall including an insulation.

The storage room may be maintained within an appropriate temperature range according to a purpose of use, and include a “refrigerating room”, a “freezing room”, and a “temperature conversion room” according to purposes of use and/or temperature ranges. The refrigerating room may be maintained at appropriate temperature to keep food refrigerating, and the freezing room may be maintained at appropriate temperature to keep food frozen. The “refrigerating” may be keeping food cold without freezing the food, and for example, the refrigerating room may be maintained within a range of 0 degrees Celsius to 7 degrees Celsius. The “freezing” may be freezing food or keeping food frozen, and for example, the freezing room may be maintained within a range of −20 degrees Celsius to −1 degrees Celsius. The temperature conversion room may be used as any one of a refrigerating room or a freezing room according to or regardless of a user's selection.

The storage room may also be called various other terms, such as “vegetable room”, “freshness room”, “cooling room”, and “ice-making room”, in addition to “refrigerating room”, “freezing room”, and “temperature conversion room”, and the terms, such as “refrigerating room”, “freezing room”, “temperature conversion room”, etc., as used below need to be understood to represent storage rooms having the corresponding purposes of use and the corresponding temperature ranges.

The refrigerator according to an embodiment of the disclosure may include at least one door configured to open or close the open side of the storage room. The respective doors may be provided to open and close one or more storage rooms, or a single door may be provided to open and close a plurality of storage rooms. The door may be rotatably or slidably mounted on the front of the main body.

The “door” may seal the storage room in a closed state. The door may include an insulation, like the main body, to insulate the storage room in the closed state.

According to an embodiment, the door may include an outer door plate forming the front surface of the door, an inner door plate forming the rear surface of the door and facing the storage room, an upper cap, a lower cap, and a door insulation provided therein.

A gasket may be provided on the edge of the inner door plate to seal the storage room by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage room, an upper cap, a lower cap, and a door insulator provided therein.

The refrigerator may be classified as French Door Type, Side-by-side Type, Bottom Mounted Freezer (BMF), Top Mounted Freezer (TMF), or One Door Refrigerator depending on the arrangement of the doors and the storage rooms.

The refrigerator according to an embodiment of the disclosure may include a cool air supply device for supplying cool air to the storage room.

The “cool air supply device” may include a machine, an apparatus, an electronic device, and/or a combination system thereof, capable of generating cool air and guiding the cool air to cool the storage room.

According to an embodiment of the disclosure, the cool air supply device may generate cool air through a cooling cycle including compression, condensation, expansion, and evaporation processes of refrigerants. To this end, the cool air supply device may include a cooling cycle device having a compressor, a condenser, an expander, and an evaporator to drive the cooling cycle. According to an embodiment of the disclosure, the cool air supply device may include a semiconductor such as a thermoelectric element. The thermoelectric element may cool the storage room by heating and cooling actions through the Peltier effect.

The refrigerator according to an embodiment of the disclosure may include a machine room where at least some components belonging to the cool air supply device are installed.

The “machine room” may be partitioned and insulated from the storage room to prevent heat generated from the components installed in the machine room from being transferred to the storage room. To dissipate heat from the components installed inside the machine room, the machine room may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice generated in the ice-making tray.

The refrigerator according to an embodiment of the disclosure may include a controller for controlling the refrigerator.

The “controller” may include a memory for storing and/or memorizing data and/or programs for controlling the refrigerator, and a processor for outputting control signals for controlling the cool air supply device, etc. according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit (NPU) that performs an operation of an artificial intelligence (AI) model. In addition, the processor may include a central processing unit (CPU), a graphics processor (GPU), and the like. The processor may generate a control signal to control the operation of the cool air supply device. For example, the processor may receive temperature information of the storage room from a temperature sensor, and generate a cooling control signal for controlling an operation of the cool air supply device based on the temperature information of the storage room.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cool air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

The terms “up,” “down,” “front,” “rear,” and the like used in the following description are defined with reference to the drawings, and the shape and position of each element are not limited by these terms. For example, the terms “front” and “rear” below may refer to the front and rear of the refrigerator in an X direction relative to the drawings, respectively. The terms “up” and “down” may refer to upwardly in a Z-direction and downwardly in the Z-direction of the refrigerator, respectively, relative to the drawings. The terms “left” and “right” may refer to the left side of the refrigerator in a Y-direction and the right side of the refrigerator in the Y-direction, respectively, relative to the drawings.

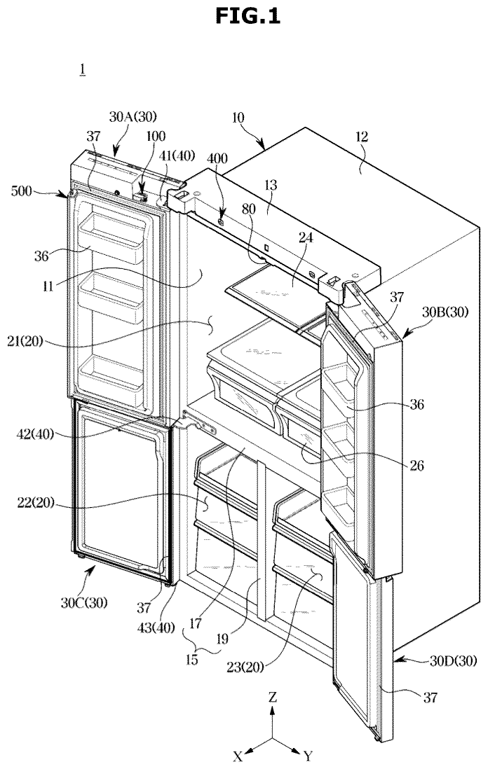

FIG. 1 is a perspective view of a refrigerator according to one embodiment of the disclosure.

Referring to FIG. 1, a refrigerator 1 according to one embodiment of the disclosure may include a main body 10, a storage compartment 20 disposed inside the main body 10, a door 30 configured to open and close the storage compartment 20, and a cooling system for supplying cold air to the storage compartment 20.

The main body 10 may include an inner case 11 provided to form the storage compartment 20 and an outer case 12 provided to form an exterior of the refrigerator 1.

The outer case 12 may be formed to have the shape of a box in which a front surface is open. The outer case 12 may form an upper surface, a lower surface, left and right surfaces, a rear surface, etc. of the refrigerator 1.

A front surface of the inner case 11 may be open. The storage compartment 20 may be disposed in the inner case 11 and the inner case 11 may be disposed inside the outer case 12. An inner wall of the inner case 11 may form an inner wall of the storage compartment 20.

A body insulation material may be disposed between the outer case 12 and the inner case 11 of the main body 10 to allow the outer case 12 and the inner case 11 to be insulated from each other.

The storage compartment 20 may be formed inside the main body 10. For example, the storage compartment 20 may include a refrigerating compartment in which food is kept refrigerated by maintaining the temperature at approximately 0 to 5 degrees Celsius. For example, the storage compartment 20 may include a freezing compartment in which food is kept frozen by maintaining the temperature at approximately −30 to 0 degrees Celsius.

For example, the storage compartment 20 may be divided into a plurality of regions by a partition 15. Particularly, by a first partition 17 extending in the horizontal direction, the storage compartment 20 may be divided into a first storage compartment 21 disposed in an upper portion thereof and lower storage compartments 22 and 23 disposed in a lower portion thereof. In addition, the storage compartments 22 and 23 disposed in the lower portion the storage compartment 20 may be divided into a second storage compartment 22 on the left and a third storage compartment 23 on the right by a second partition 19 extending in the vertical direction. In this case, the first storage compartment 21 may be used as the refrigerating compartment. Both the second storage compartment 22 and the third storage compartment 23 may be used as the freezing compartment. Alternatively, one of the second storage compartment 22 and the third storage compartment 23 may be used as the freezing compartment and the other of the second storage compartment 22 and the third storage compartment 23 may be used as the refrigerating compartment.

The division method of the storage compartment 20 and the purposes of each of the divided storage compartments 21, 22, and 23 are only examples and are not limited thereto.

A shelf 24 on which food is placed and a storage container 26 in which food is stored may be provided in the storage compartment 20.

The refrigerator 1 may include a cooling system configured to generate cold air using a cooling cycle and supply the generated cold air to the storage compartment 20. The cooling system may generate cold air using a refrigeration circulation cycle that compresses, condenses, expands, and evaporates a refrigerant. For example, the cooling system may include a compressor, a condenser, an expansion valve, an evaporator, a blower fan, etc.

The main body 10 may include a cold air supply duct provided to form a cold air flow path through which cold air generated by the cooling system flows into the storage compartment 20. The cold air supply duct may be formed in a rear portion of the inner case 11, and may be disposed at the rear of the storage compartment 20 and communicate with the storage compartment 20.

The door 30 may be configured to open and close the storage compartment 20. The door 30 may be configured to open and close an opening formed on one side of the main body 10. The door 30 may be configured to be rotatable with respect to the main body 10.

An outer surface of the door 30 may form a portion of the exterior of the refrigerator 1. When the door 30 is in a closed position, the outer surface of the door 30 may form at least a portion of a front exterior of the refrigerator 1. When the door 30 is in the closed position, an inner surface of the door 30 may face the inside of the storage compartment 20. The inner surface of the door 30 refers to one surface of the door 30 facing the storage compartment 20 when the door 30 closes the storage compartment 20. In addition, the outer surface of the door 30 refers to the other surface opposite to the inner surface of the door 30 facing the storage compartment 20 when the door 30 closes the storage compartment 20, and refers to the front surface of the door 30 when the refrigerator 1 is viewed from the front.

A door gasket 37 provided to seal a gap between the door 30 and the main body 10 to prevent cold air from leaking into the storage compartment 20 may be disposed on the inner surface of the door 30. The door gasket 37 may be arranged along an inner circumference of the door 30. The door gasket 37 may be formed of an elastic material such as rubber.

The refrigerator 1 may include a plurality of doors 30A, 30B, 30C, and 30D configured to open and close each partitioned storage compartment 21, 22, and 23.

Particularly, the first storage compartment 21 may be opened and closed by a pair of upper doors 30A and 30B. The refrigerator 1 may include a first door 30A configured to open and close a portion of the first storage compartment 21 and a second door 30B configured to open and close another portion of the first storage compartment 21. The first door 30A and the second door 30B may each be rotatable independently of each other with respect to the main body 10.

The first door 30A and the second door 30B may be arranged side by side with each other. Particularly, the first door 30A and the second door 30B may be arranged side by side in the horizontal direction (Y direction). For example, the first door 30A may be configured to open and close a left portion of the first storage compartment 21, and the second door 30B may be configured to open and close a right portion of the first storage compartment 21.

The refrigerator 1 may include a rotation bar 500. The rotation bar 500 may be configured to be rotatable with respect to one of the pair of upper doors 30A and 30B (e.g., first door 30A), and provided to cover a gap between the pair of upper doors 30A and 30B when the pair of upper doors 30A and 30B closes the first storage compartment 21.

Further, the second storage compartment 22 may be opened and closed by a lower left door 30C. The refrigerator 1 may include a third door 30C configured to open and close the second storage compartment 22. The third door 30C may be configured to be rotatable with respect to the main body 10. For example, the first door 30A and the third door 30C may be arranged side by side in the vertical direction (Z).

Further, the third storage compartment 23 may be opened and closed by a lower right door 30D. The refrigerator 1 may include a fourth door 30D configured to open and close the third storage compartment 23. The fourth door 30D may be configured to be rotatable with respect to the main body 10. For example, the second door 30B and the fourth door 30D may be arranged side by side in the vertical direction (Z). Additionally, the third door 30C and the fourth door 30D may be arranged side by side in the horizontal direction (Y).

For example, a handle may be provided on each of the plurality of doors 30A, 30B, 30C, and 30D, and a user can hold the handle provided on each of the plurality of doors 30A, 30B, 30C, and 30D to open and close each door 30A, 30B, 30C, and 30D. In other words, a user can open or close each storage compartment 21, 22, and 23 by holding the handle provided on each of the plurality of doors 30A, 30B, 30C, and 30D.

For example, the handle provided on each of the plurality of doors 30A, 30B, 30C, and 30D may include a concave groove shape for gripping.

For example, a door basket 36 provided to store food may be disposed on a rear surface of the first door 30A. For example, the door basket 36 provided to store food may be disposed on a rear surface of the second door 30B.

The refrigerator 1 may include a hinge bracket 40 provided to connect the main body 10 and the door 30. The hinge bracket 40 may be provided to allow the door 30 to be rotatable with respect to the main body 10.

The hinge bracket 40 may be fixed to the main body 10. Particularly, the hinge bracket 40 may be coupled to the outer case 12.

The hinge bracket 40 may rotatably support the door 30. The door 30 may be rotatably coupled to the main body 10 by the hinge bracket 40. A rotation axis of the door 30 may pass through the hinge bracket 40.

Particularly, the refrigerator 1 may include a plurality of hinge brackets 41, 42, and 43 provided to support each of the plurality of doors 30A, 30B, 30C, and 30D.

For example, the refrigerator 1 may include an upper door hinge bracket 41. The upper door hinge bracket 41 may be coupled to an upper portion of the main body 10. For example, the upper door hinge bracket 41 may be provided as a pair so as to rotatably support the first door 30A and the second door 30B, respectively. The pair of upper door hinge brackets 41 may be disposed on the upper left and upper right sides of the main body 10, respectively. Each of the pair of upper door hinge brackets 41 may be coupled to an upper portion of the first door 30A and an upper portion of the second door 30B.

For example, the refrigerator 1 may include a lower door hinge bracket 43. The lower door hinge bracket 43 may be coupled to a lower portion of the main body 10. For example, the lower door hinge bracket 43 may be provided as a pair so as to rotatably support the third door 30C and the fourth door 30D, respectively. The pair of lower door hinge brackets 43 may be disposed on the lower left and lower right sides of the main body 10, respectively. Each of the pair of lower door hinge brackets 43 may be coupled to a lower portion of the third door 30C and a lower portion of the fourth door 30D.

For example, the refrigerator 1 may include an intermediate hinge bracket 42. The intermediate hinge bracket 42 may be coupled to a middle portion of the main body 10. The intermediate hinge bracket 42 may be disposed between the upper door hinge bracket 41 and the lower door hinge bracket 43. For example, the intermediate hinge bracket 42 may be provided as a pair so as to rotatably support the first door 30A and the second door 20B, respectively. Additionally, the intermediate hinge brackets 42 may be provided as a pair so as to rotatably support the third door 30C and the fourth door 30D, respectively. The pair of intermediate hinge brackets 42 may be provided on the left and right sides of the middle portion of the main body 10, respectively. Each of the pair of intermediate hinge brackets 42 may be coupled to the lower portion of the first door 30A and the lower portion of the second door 20B. Additionally, each of the pair of intermediate hinge brackets 42 may be coupled to the upper portion of the third door 30C and the upper portion of the fourth door 30D.

The upper door hinge bracket 41 and the intermediate hinge bracket 42 may be arranged side by side along the direction in which the rotation axes of the first door 30A and the second door 30B extend. As shown in FIG. 1, the upper door hinge bracket 41 and the intermediate hinge bracket 42 may be arranged side by side in the vertical direction (Z).

The lower door hinge bracket 43 and the intermediate hinge bracket 42 may be arranged side by side along the direction in which the rotation axes of the third door 30C and the fourth door 30D extend. As shown in FIG. 1, the lower door hinge bracket 43 and the intermediate hinge bracket 42 may be arranged side by side in the vertical direction (Z).

The main body 10 may further include a top table 13 disposed on the upper portion of the main body 10. Particularly, the top table 13 may be coupled to the upper portion of the outer case 12. The top table 13 may be coupled to an upper surface of the outer case 12. The top table 13 may be fixed to the outer case 12.

The top table 13 may cover the upper door hinge bracket 41. Accordingly, the top table 13 may be referred to as ‘hinge bracket cover 13’.

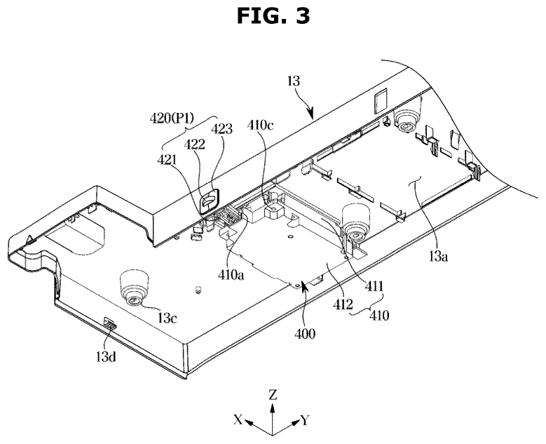

The top table 13 may cover various electrical components. An accommodating space 13a (refer to FIG. 3 in which various electrical components are accommodated may be formed in the top table 13. Particularly, the top table 13 may cover a door opening device 400, which will be described later, and the door opening device 400 may be accommodated in the top table 13. Accordingly, the top table 13 may be referred to as ‘door opening device cover 13’.

A detailed description of the structure of the top table 13 will be described later.

The configuration of the refrigerator 1 described above with reference to FIG. 1 is only an example for describing the refrigerator according to the disclosure, and the disclosure is not limited thereto. The refrigerator according to the disclosure may be provided to include various configurations to perform the function of supplying cold air to the storage compartment for storing food.

The type of refrigerator, to which the refrigerator according to the disclosure is applied, is not limited to the type of refrigerator 1 shown in the drawing, and the refrigerator according to the disclosure may include various types of refrigerators such as side-by-side type, French door type, Bottom Mounted Freezer (BMF) type, Top Mounted Freezer (TMF) type or one-door type.

In addition, the refrigerator 1 according to one embodiment of the disclosure is described on the assumption that the refrigerator is an indirect cooling type, but is not limited thereto. The disclosure may be applied to a direct cooling type refrigerator.

Hereinafter for convenience of description, the refrigerator according to the disclosure will be described based on the refrigerator 1 according to one embodiment shown in FIGS. 1 to 22.

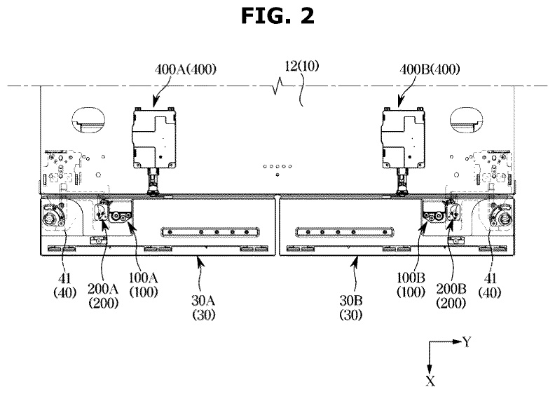

FIG. 2 is a top view illustrating a top table separated from the refrigerator according to one embodiment of the disclosure.

Referring to FIG. 2, the refrigerator 1 according to one embodiment of the disclosure may include the door opening device 400 configured to open the door 30.

The door opening device 400 may be configured to open the door 30. The door opening device 400 may be configured to rotate the door 30 with respect to the main body 10 to open the storage compartment 20.

Particularly, the door opening device 400 may be mounted on the main body 10. In a state in which the door opening device 400 is mounted on the main body 10, the door opening device 400 may open the door 30 by pressing the door 30 toward an opening direction. The door opening device 400 may be configured to press the door 30 based on a door opening signal being input through a switch (60, see FIG. 3).

The door opening device 400 may be configured to open the first storage compartment 21. That is, the refrigerator 1 may include a first door opening device 400A configured to open the first door 30A, and a second door opening device 400B configured to open the second door 30B.

Particularly, the first door opening device 400A may be configured to open the first door 30A. The first door opening device 400A may be configured to open the first door 30A based on input of a first door opening signal for opening the first door 30A. The first door opening device 400A may be configured to open a portion of the first storage compartment 21 by rotating the first door 30A with respect to the main body 10.

Further, the second door opening device 400B may be configured to open the second door 30B. The second door opening device 400B may be configured to open the second door 30B based on input of a second door opening signal for opening the second door 30B. The second door opening device 400B may be configured to open another portion of the first storage compartment 21 by rotating the second door 30B with respect to the main body 10.

The first door opening device 400A and the second door opening device 400B may be configured to open the first storage compartment 21 independently of each other.

In this case, the door opening device 400 may be mounted on the upper portion of the main body 10. Particularly, the door opening device 400 may be accommodated inside the top table 13. The upper portion of the door opening device 400 may be covered by the top table 13. The door opening device 400 may be disposed on the upper surface of the outer case 12. For example, the first door opening device 400A may be disposed on the left side of the upper portion of the main body 10 with respect to a center of the main body, and the second door opening device 400B may be disposed on the right side of the upper portion of the main body 10. That is, the first door opening device 400A and the second door opening device 400B may be arranged side by side in the horizontal direction (Y).

The door opening device 400 may be mounted on the upper portion of the main body 10 so as to press the upper portion of the door 30. For example, the first door opening device 400A may be configured to press the upper portion of the first door 30A. Further, the second door opening device 400B may be configured to press the upper portion of the second door 30B.

However, the disclosure is not limited thereto, and the door opening device 400 may be mounted in various positions of the main body 10 and configured to open the first storage compartment 21 by pressing various portions other than the upper portion of the first door 30A or the second door 30B.

For example, unlike FIG. 2, the door opening device 400 may be mounted on the horizontal partition 17 to press the lower portion of the first door 30A or the second door 30B.

Further, unlike FIG. 2, the door opening device 400 may be configured to open the second storage compartment 22. That is, the door opening device 400 may be configured to press the third door 30C based on input of a third door opening signal for opening the second storage compartment 22. In this case, the door opening device 400 may be mounted on the lower portion of the main body 10 or on the horizontal partition 17.

Further, unlike FIG. 2, the door opening device 400 may be configured to open the third storage compartment 23. That is, the door opening device 400 may be configured to press the fourth door 30D based on input of a fourth door opening signal for opening the third storage compartment 23. In this case, the door opening device 400 may be mounted on the lower portion of the main body 10 or on the horizontal partition 17.

Hereinafter for convenience of description, the door opening device 400 will be described based on an example in which the door opening device 400 is mounted to the upper portion of the main body 10 and configured to open the first storage compartment 21 by pressing the first door 30A or the second door 30B.

Hereinafter for convenience of description, the first door opening device 400A among the first door opening device 400A and the second door opening device 400B will be described as an example, and for convenience, the first door opening device 400A may be referred to as ‘door opening device 400’. Features of the door opening device 400 described below may be correspondingly applied to the second door opening device 400B.

Referring to FIG. 2, the refrigerator 1 according to one embodiment of the disclosure may include a door opening and closing guide module configured to guide the opening and closing of the door 30.

Particularly, the refrigerator 1 may include a guide 200. The guide 200 may be provided to guide rotation of the door 30 while the door 30 is being opened or closed. In other words, the guide 200 may be provided to guide the door 30 to rotate in a specific direction according to the position of the door 30. In other words, the guide 200 may be provided to assist in opening or closing the door 30 according to the position of the door 30.

Particularly, the guide 200 may be provided to apply a force to the door 30 in the direction, in which the door 30 is opened or closed, according to the position of the door 30 while the door 30 is being opened or closed. Whether the door 30 receives a force in an opening direction or a closing direction by the guide 200 may vary according to the relative position of the door 30 with respect to the guide 200. That is, the guide 200 may guide the rotation of the door 30 to allow the door 30 to rotate in the opening direction when the door 30 is located at a specific position while the door 30 is being opened. Further, the guide 200 may guide the rotation of the door 30 to allow the door 30 to rotate in the closing direction when the door 30 is located at a specific position while the door 30 is being closed.

The guide 200 may be fixed to the main body 10. For example, the guide 200 may be coupled to the hinge bracket 40. As shown in FIG. 2, the guide 200 may be coupled to the upper door hinge bracket 41. Alternatively, the guide 200 may be formed integrally with the upper door hinge bracket 41.

The refrigerator 1 may include a lever device 100. The lever device 100 may be mounted on the door 30. As shown in FIG. 2, the lever device 100 may be mounted on the upper portion of the door 30.

The lever device 100 may include a lever provided to be in contact with the guide 200 while the door 30 is being opened or closed. lever When the lever is in contact with the guide 200, a force applied to the lever device 100 from the guide 200 may vary according to the relative position of the lever with respect to the guide 200. ‘The force applied to the lever device 100 from the guide 200 varies’ means that a magnitude or direction of a force applied from the guide 200 to the lever device 100 may be changed according to the relative position of the lever with respect to the guide 200. Accordingly, according to the relative position of the lever with respect to the guide 200 when the lever is in contact with the guide 200, the lever device 100 may transmit a force to the door 30 in the direction in which the door 30 is opened or a force to the door 30 in the direction in which the door 30 is closed.

The door opening and closing guide module may be provided to guide the opening and closing of each of the first door 30A and the second door 30B.

Particularly, the refrigerator 1 may include a first guide 200A provided to guide the rotation of the first door 30A while the first door 30A is being opened or closed. The first guide 200A may be fixed to the main body 10. For example, the first guide 200A may be coupled to the upper door hinge bracket 41 connected to the first door 30A among the pair of upper door hinge brackets 41. In other words, as shown in FIG. 2, the first guide 200A may be coupled to the upper door hinge bracket 41 disposed on the left side.

Further, the refrigerator 1 may include a first lever device 100A mounted on the first door 30A. For example, the first lever device 100A may be mounted on an upper portion of the first door 30A. The lever of the first lever device 100A may be provided to be in contact with the first guide 200A while the first door 30A is being opened or closed. According to the position of the first door 30A while the first door 30A is being opened or closed, the first lever device 100A may be provided to apply a force to the first door 30A in the direction in which the first door 30A is opened or apply a force to the first door 30A in the direction in which the first door 30A is closed. In detail, when the first door 30A is located at a position rotated by less than a predetermined angle from a closed position, the lever of the first lever device 100A may be in contact with a first contact surface of the first guide 200A. The first contact surface may apply, via the lever, a force to the first door 30A in a direction in which the first door 30A is closed. When the first door 30A is located at a position rotated by more than the predetermined angle from the closed position, the lever of the first lever device 100A may be in contact with a second contact surface of the first guide 200A. The second contact surface may apply, via the lever, a force to the first door 30A in a direction in which the first door 30A is opened. Further, the refrigerator 1 may include a second guide 200B provided to guide the rotation of the second door 30B while the second door 30B is being opened or closed. The second guide 200B may be fixed to the main body 10. For example, the second guide 200B may be coupled to the upper door hinge bracket 41 connected to the second door 30B among the pair of upper door hinge brackets 41. In other words, as shown in FIG. 2, the second guide 200B may be coupled to the upper door hinge bracket 41 disposed on the right side.

Further, the refrigerator 1 may include a second lever device 100B mounted on the second door 30B. For example, the second lever device 100B may be mounted on an upper portion of the second door 30B. A lever of the second lever device 100B may be provided to be in contact with the second guide 200B while the second door 30B is being opened or closed. According to the position of the second door 30B while the second door 30B is being opened or closed, the second lever device 100B may be provided to apply a force to the first door 30A in the direction in which the second door 30B is opened or apply a force to the second door 30B in the direction in which the second door 30B is closed. In detail, when the second door 30B is located at a position rotated by less than a predetermined angle from a closed position, the lever of the second lever device 100B may be in contact with a first contact surface of the second guide 200B. The first contact surface may apply, via the lever, a force to the second door 30B in a direction in which the second door 30B is closed. When the second door 30B is located at a position rotated by more than the predetermined angle from the closed position, the lever of the second lever device 100B may be in contact with a second contact surface of the second guide 200B. The second contact surface may apply, via the lever, a force to the second door 30B in a direction in which the second door 30B is opened.

However, the arrangement of the door opening and closing guide structure, such as the lever device 100 and the guide 200, is not limited thereto.

For example, unlike FIG. 2, the lever device 100 may be mounted on a lower portion of the first door 30A or the second door 30B, and the guide 200 may be mounted on the intermediate hinge bracket 42.

For example, unlike FIG. 2, the guide 200 may be provided to guide the rotation of the third door 30C. The guide 200 may be provided to transmit a force to the third door 300C when the third door 30C rotates. In this case, the guide 200 may be disposed on the lower door hinge bracket 43 or the intermediate hinge bracket 42. Additionally, when the third door 30C rotates, the lever device 100 may be provided to be in contact with the guide 200 and may be provided to transmit a force to the third door 30C. In this case, the lever device 100 may be mounted on the lower or upper portion of the third door 30C to correspond to the position of the guide 200.

For example, unlike FIG. 2, the guide 200 may be provided to guide the rotation of the fourth door 30D. The guide 200 may be provided to transmit a force to the fourth door 30D when the fourth door 30D rotates. In this case, the guide 200 may be disposed on the lower door hinge bracket 43 or the intermediate hinge bracket 42. Additionally, when the fourth door 30D rotates, the lever device 100 may be provided to be in contact with the guide 200, and may be provided to transmit a force to the fourth door 30D. In this case, the lever device 100 may be mounted on the lower or upper portion of the fourth door 30D to correspond to the position of the guide 200.

The door 30 may be configured to be rotatable between an open position that opens the storage compartment 20 to the maximum and a closed position that closes the storage compartment 20. That is, the storage compartment 20 may be opened when the door 30 rotates from the closed position to the open position, and the storage compartment 20 may be closed when the door 30 rotates from the open position to the closed position. The open and closed positions of the door 30 may be defined as positions relative to the main body 10 and the storage compartment 20.

For example, an open position of the door 30 may be a position in which the door 30 is rotated by approximately 80 to 120 degrees from a closed position. However, the angle by which the door 30 is rotated from the closed position when the door 30 is in the open position is not limited thereto.

The door 30 may be configured to be rotatable about a rotation axis extending in one direction. For example, the door 30 may be configured to be rotatable about the rotation axis extending in the vertical direction (Z).

The rotation axis of the door 30 may be determined differently depending on the connection relationship between the door 30 and the main body 10. The rotation axis of the door 30 may pass through the door 30 and the hinge bracket 40. Accordingly, the door 30 may be rotatable relative to the hinge bracket 40 with respect to the rotation axis.

As illustrated in FIG. 2, when the hinge bracket 40 is fixed to the main body 10 and a portion, in which the door 30 and the hinge bracket 40 are connected to each other, is fixed to the main body 10, the rotation axis of the door 30 may be defined as an imaginary straight line fixed to the main body 10. That is, the door 30 may be configured to be rotatable between the open position and the closed position with respect to the rotation axis that is fixed to the main body 10.

However, when the hinge bracket 40 moves relative to the main body 10 and a portion, in which the door 30 and the hinge bracket 40 are connected to each other, moves relative to the main body 10 (e.g., a multiple-joint hinge bracket type in which the hinge bracket includes a plurality of links rotatably connected to each other) when the door 30 opens or closes the storage compartment 20, the rotation axis of the door 30 may not be fixed to the main body 10.

The above-described door opening device 400 may be configured to rotate the door 30 from the closed position to the open position. The door opening device 400 may press the door 30 and rotate the door 30 toward the open position.

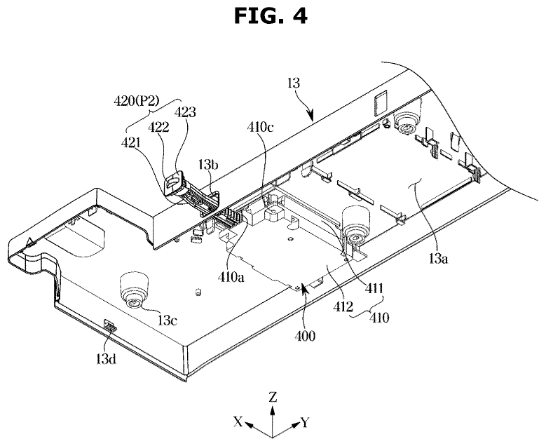

FIG. 3 is a view illustrating the top table and a door opening device of the refrigerator according to one embodiment of the disclosure when a door pusher is located at a first pusher position. FIG. 4 is a view illustrating the top table and the door opening device of the refrigerator according to one embodiment of the disclosure when the door pusher is located at a second pusher position.

Referring to FIGS. 3 and 4, the door opening device 400 of the refrigerator 1 according to one embodiment of the disclosure may include a door pusher 420. The door pusher 420 may be configured to press the door 30 to open the door 30.

The door pusher 420 may be mounted on the main body 10. The door pusher 420 may be supported by a pusher case 410, which will be described later, and the pusher case 410 may be fixed to the main body 10. Accordingly, the door pusher 420 may be mounted on the main body 10 through the pusher case 410.

The door opening device 400 may include the pusher case 410 provided to support the door pusher 420. The pusher case 410 may accommodate at least a portion of the door pusher 420.

The pusher case 410 may be mounted on the main body 10. The pusher case 410 may be fixed to the main body 10.

For example, the pusher case 410 may be mounted on the top table 13. The pusher case 410 may include a fixing portion 410c coupled to the top table 13 and fixed to the main body 10. For example, the pusher case 410 may be fixed to the top table 13 by a fastening member (e.g., screw) that penetrates the fixing portion 410c.

The top table 13 may be fixed to the outer case 12. The top table 13 may include an outer case coupling portion provided to be fixed to the outer case 12. For example, the top table 13 may be fixed to the outer case 12 by screwing an outer case coupling portion 13c to one surface of the outer case 12 or the hinge bracket 40. Alternatively, the top table 13 may be fixed to the outer case 12 by hooking an outer case coupling portion 13d to the outer case 12 or the hinge bracket 40. As the top table 13 is fixed to the outer case 12, the door opening device 400 including the pusher case 410 may be stably mounted to the main body 10.

For example, the pusher case 410 may be covered by the top table 13. The pusher case 410 may be accommodated inside the top table 13. The top table 13 may be coupled to the inside of the top table 13. The top table 13 may include the accommodating space 13a provided to accommodate the door opening device 400, and the pusher case 410 may be disposed inside the accommodating space 13a.

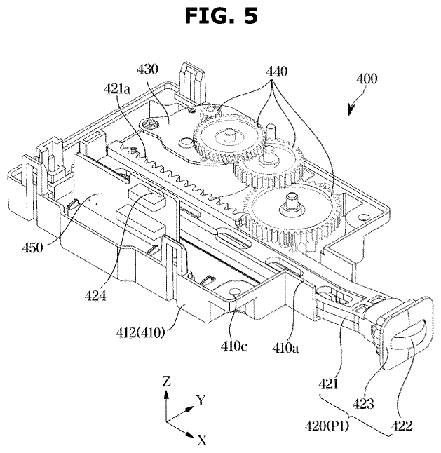

For example, the pusher case 410 may include a first pusher case 411 and a second pusher case 412. The first pusher case 411 and the second pusher case 412 may be coupled to each other. Between the first pusher case 411 and the second pusher case 412, an accommodating space may be formed to accommodate various components of the door opening device 400, such as the door pusher 420 (refer to FIG. 5, etc.).

For example, the first pusher case 411 may be disposed above the second pusher case 412. The first pusher case 411 and the second pusher case 412 may be coupled to each other in the vertical direction.

However, the disclosure is not limited thereto, and the pusher case 410 may include various structures.

The door pusher 420 may be configured to be movable with respect to the main body 10. The door pusher 420 may be configured to press the door 30 while moving relative to the main body 10. The door pusher 420 may be movably mounted on the main body 10.

The door pusher 420 may be movable in the pusher case 410. The pusher case 410 may movably support the door pusher 420. As the door pusher 420 is movably supported on the pusher case 410 and the pusher case 410 is fixed to the main body 10, the door pusher 420 may be mounted on the main body 10 and at the same time, the door pusher 420 may be movable relative to the main body 10.

The door pusher 420 may be movable with respect to the accommodating space 13a within the top table 13. The door pusher 420 may be inserted into the accommodating space 13a and accommodated within the accommodating space 13a, or may be withdrawn from the accommodating space 13a to press the door 30.

The top table 13 may include an opening 13b formed on one side of the accommodating space 13a. The door pusher 420 may be provided to penetrate the opening 13b and be movable with respect to the accommodating space 13a. The opening 13b may be formed on one surface of the top table 13 facing the door 30 when the door 30 is closed. For example, the opening 13b may be formed on one front surface of the top table 13.

The door pusher 420 may be movable between a first pusher position P1 and a second pusher position P2. Particularly, the door pusher 420 may be configured to perform reciprocating movement between the first pusher position P1 and the second pusher position P2.

The first pusher position P1 may be a position of the door pusher 420 when the door 30 is closed. The second pusher position P2 may be a position when the door pusher 420 moves from the first pusher position P1 to a direction of pressing the door 30. The door pusher 420 may move from the first pusher position P1 to the second pusher position P2 and press the closed door 30 so as to open the closed door 30. The second pusher position P2 may be a position in which the door pusher 420 moves forward from the first pusher position P1.

The door pusher 420 may be accommodated in the accommodating space 13a of the top table 13 when the door pusher 420 is positioned in the first pusher position P1. That is, the door pusher 420 may be in a state of being inserted into the accommodating space 13a of the top table 13 when the door pusher 420 is positioned at the first pusher position P1. The door pusher 420 may be withdrawn from the accommodating space 13a and moved from the first pusher position P1 to the second pusher position P2. While the door pusher 420 penetrates the opening 13b of the top table 13, the door pusher 420 may be movable between the first pusher position P1 and the second pusher position P2.

For example, as shown in FIGS. 3 and 4, the door pusher 420 may be provided to be linearly movable between the first pusher position P1 and the second pusher position P2. As shown in the drawing, the door pusher 420 may be configured to move linearly in the front and rear direction (X). However, the door pusher 420 may move non-linearly between the first pusher position P1 and the second pusher position P2.

The door pusher 420 may move from a first pusher position P1 to a second pusher position P2 based on input of a door opening signal.

The door pusher 420 may be configured to press the door 30 until the door pusher 420 reaches the second pusher position P2. Thereafter, based on reaching the second pusher position P2, the door pusher 420 may stop moving or move to the first pusher position P1. In this case, the door pusher 420 may no longer press the door 30.

The door pusher 420 may include a movable rod 421 configured to be movable with respect to the main body 10. The movable rod 421 may be configured to be movable with respect to the pusher case 410. The movable rod 421 may be supported on the pusher case 410. At least a portion of the movable rod 421 may be accommodated in the pusher case 410.

The movable rod 421 may be provided to be movable with respect to the accommodating space 13a of the top table 13. At least a portion of the movable rod 421 may be accommodated in the accommodating space 13a. The movable rod 421 may be inserted into or withdrawn from the accommodating space 13a.

When the door pusher 420 is located at the first pusher position P1, the position of the moving rod 421 may be referred to as a “first position.” When the door pusher 420 is located at the second pusher position P2, the position of the moving rod 421 may be referred to as a “second position.” The moving rod 421 may be provided to be movable between the first position and the second position. When the door opening device 400 opens the door 30, the moving rod 421 may move relative to the main body 10 from the first position toward the second position in a direction in which the door 30 is opened.

When the moving rod 421 moves from the first position to the second position, the moving rod 421 may be withdrawn from the accommodation space 13a through the opening 13b. When the moving rod 421 moves from the second position to the first position, the moving rod 421 may be inserted into the accommodation space 13a through the opening 13b.

For example, the movable rod 421 may be configured to move linearly between the first position and the second position with respect to the main body 10. The movable rod 421 may be configured to move linearly between the first position and the second position with respect to the pusher case 410.

The door pusher 420 may include a push roller 422. The push roller 422 may be provided on one side of the movable rod 421 with respect to the direction of pressing the door 30. When the door pusher 420 moves from the first pusher position P1 to the second pusher position P2, the movable rod 422 may be in contact with the door 30. When the moving rod 421 moves from the first position toward the second position, the push roller 422 may press the door 30. When the moving rod 421 moves in a direction in which the moving rod 421 is withdrawn from the accommodation space 13a, the push roller 422 may press the door 30. That is, the door 30 may be pressed by the push roller 422.

The push roller 422 may be configured to be rotatable with respect to the movable rod 421. The push roller 422 may be configured to be rotatable with respect to the movable rod 421. The push roller 422 may be coupled to one side of the moving rod 421 so as to be rotatable relative to the moving rod 421.

As the rotatable push roller 422 is provided on one side of the movable rod 421, friction between the door pusher 420 and the door 30 may be reduced, and it is possible to prevent abrasion of the door pusher 420 and the door 30. Accordingly, the door 30 may be opened more efficiently.

A detailed description of the structure of the push roller 422 will be described later.

The door pusher 420 may include an opening cover 423. The opening cover 423 may be provided to cover the opening 13b of the top table 13 when the door pusher 420 is located in the first pusher position P1. The opening cover 423 may be provided to seal a gap between the door pusher 420 and the opening 13b when the door pusher 420 is located in the first pusher position P1. The opening cover 423 may be provided on one side of the moving rod 421.

The structure of the opening cover 423 will be described in detail later.

Meanwhile, although the above description has been made on the premise that the accommodation space 13a accommodating the door opening device 400 is formed by the top table 13 of the main body 10, the disclosure is not limited thereto, and the door opening device 400 may be accommodated in accommodation spaces formed in various portions of the body 10. In addition, although the above description has been made on the premise that the opening 13b penetrated by the door pusher 420 is formed in the top table 13, the disclosure is not limited thereto, and the opening penetrated by the door pusher 420 may be formed in various portions of the body 10.

As mentioned above, the door opening device 400 may open the door 30 by including the door pusher 420 configured to be movable with respect to the main body 10 and configured to press the door 30.

An example of a structure included in the door opening device 400 will be described with reference to FIGS. 5 to 9.

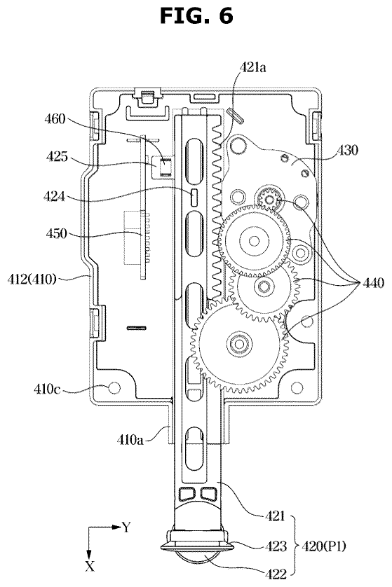

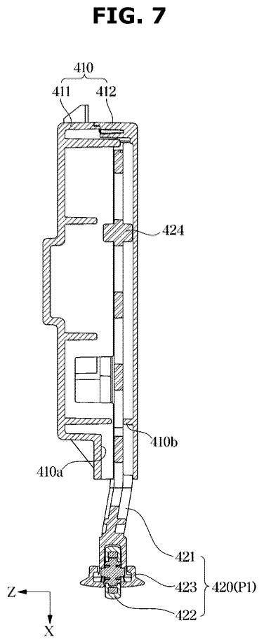

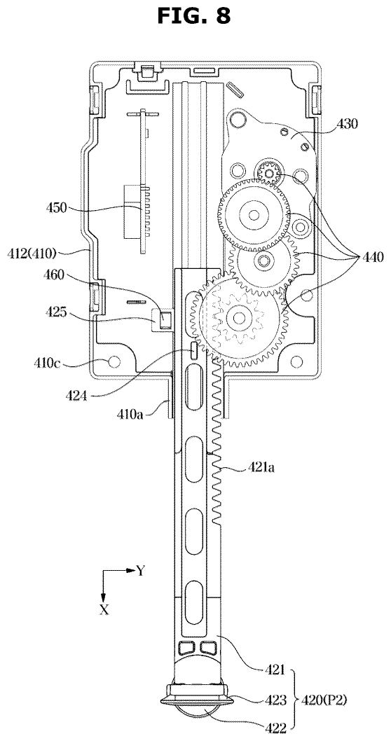

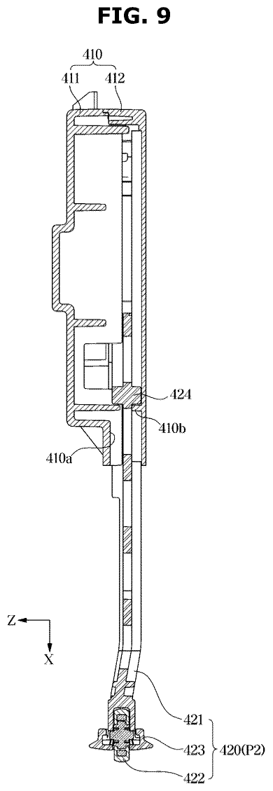

FIG. 5 is a view illustrating a partial configuration of the door opening device of the refrigerator according to one embodiment of the disclosure. FIG. 6 is a view illustrating a partial configuration of the door opening device of the refrigerator according to one embodiment of the disclosure when the door pusher is at the first pusher position. FIG. 7 is a cross-sectional view of the door opening device of the refrigerator according to one embodiment of the disclosure when the door pusher is at the first pusher position. FIG. 8 is a view illustrating a partial configuration of the door opening device of the refrigerator according to one embodiment of the disclosure when the door pusher is at the second pusher position. FIG. 9 is a cross-sectional view of the door opening device of the refrigerator according to one embodiment of the disclosure when the door pusher is at the second pusher position.

Referring to FIGS. 5 to 9, the door opening device 400 of the refrigerator 1 according to one embodiment of the disclosure may include a power source 430 configured to generate power for the door pusher 420 to move. The power source 430 may generate power that is required for the door pusher 420 when the door pusher 420 moves between the first pusher position P1 and the second pusher position P2.

For example, the power source 430 may include a drive motor and a motor driver connected to the drive motor. The drive motor may generate power by accommodating a drive current from the motor driver. The motor driver may be electrically connected to a controller of the refrigerator 1 and may operate based on control signals received from the controller.

The power source 430 may be supported by the pusher case 410. The power source 430 may be accommodated inside the pusher case 410.

The door opening device 400 may include a power transmission member 440 provided to transmit power generated by the power source 430 to the door pusher 420.

The power transmission member 440 may be supported by the pusher case 410. The power transmission member 440 may be accommodated inside the pusher case 410.

The door pusher 420 may include a structure configured to receive power from the power transmission member 440. Particularly, the structure configured to receive power from the power transmission member 440 may be disposed in the movable rod 421. Accordingly, the power generated by the power source 430 may be transmitted to the door pusher 420 through the power transmission member 440.

For example, the power transmission member 440 may include at least one gear. As shown in FIG. 5, the power transmission member 440 may include a plurality of gears. In this case, the movable rod 421 may include a rod gear portion 421a engaged with one or more gears of the power transmission member 440, and the rod gear portion 421a may receive power from the gear of the power transmission member 440.

For example, the power transmission member 440 and the rod gear portion 421a may form a rack-pinion gear structure. Accordingly, the movable rod 421 may move linearly with respect to the pusher case 410.

The power source 430 may be controlled by the controller of the refrigerator 1. The power source 430 may be electrically connected to the controller. The controller may transmit a control signal for controlling the power source 430 to the power source 430, and the power source 430 may operate based on the control signal received from the controller.

The controller of the refrigerator 1 may control the power source 430 to move the door pusher 420 from the first pusher position P1 to the second pusher position P2 based on input of an opening signal.

For example, the condition for opening the door 30 may include that a user input for opening the door 30 is obtained.

The refrigerator 1 may include a user interface including an input button. The input button may be configured to obtain a user input for opening the door 30.

For example, the input button may include a touch sensor such as a capacitive sensor. The input button may be configured to obtain a user input for opening the door 30 when a user touches or presses the input button. However, the input button is not limited thereto, and the input button may obtain a user input in various ways.

For example, the input button may be disposed on the door 30. Particularly, the input button may be disposed on the handle of the door 30 or in a position adjacent thereto. In this case, as a user touches the handle of the door 30, the input button may easily obtain a user input to open the door 30. In addition, the input button may be disposed in various locations, such as the front surface of the door 30.

The input button may be electrically connected to the controller. The input button may transmit an electrical signal related to the obtained user input to the controller. The controller may control the power source 430 to open the door 30 based on obtaining a user input for opening the door 30 through the input button.

Meanwhile, when the door pusher 420 reaches the second pusher position P2, it may be required to control the door pusher 420 to prevent the door pusher 420 from moving further to the direction of pressing the door 30 from the second pusher position P2. Accordingly, the controller 50 may control the power source 430 to stop the movement of the door pusher 420 based on the door pusher 420 reaching the second pusher position P2.

In addition, when the door opening device 400 opens the door 30, the door pusher 420 may need to return to the first pusher position P1 immediately after the door 30 moves to the open position or between that point and a point of time in which the door 30 reaches the closed position. Accordingly, the controller 50 may control the power source 430 to move the door pusher 420 to the first pusher position P1 based on the door pusher 420 reaching the second pusher position P2.

For example, the door opening device 400 may include a position detection sensor 450 configured to detect the position of the door pusher 420.

The position detection sensor 450 may be supported on the pusher case 410. The position detection sensor 450 may be accommodated in the pusher case 410. Alternatively, the position detection sensor 450 may be configured to detect the position of the door pusher 420 from the outside of the pusher case 410.

The position detection sensor 450 may detect the position of the door pusher 420 in various ways. For example, the position detection sensor 450 may be configured to detect a magnetic field of a magnet 460 mounted on the door pusher 420. Particularly, the door pusher 420 may be provided with a magnet mounting portion 425 on which the magnet 460 is mounted, and the magnet 460 may be mounted on the magnet mounting portion 425 and move together with the door pusher 420. The position detection sensor 450 may detect changes in the magnetic field caused by the magnet 460 as the door pusher 420 moves.

For example, the magnet mounting portion 425 may be disposed on the movable rod 421. The magnet mounting portion 425 may extend from the movable rod 421 toward a direction in which the position detection sensor 450 is located.

For example, the position detection sensor 450 may include a Hall sensor configured to detect a magnetic field. However, the type of the position detection sensor 450 is not limited thereto, and the position detection sensor 450 may include various types of sensors configured to detect the position of the door pusher 420, particularly, configured to detect that at least the door pusher 420 reaches the second pusher position P2. For example, the position detection sensor 450 may include various types of sensors, such as a reed switch and an optical sensor.

The position detection sensor 450 may be electrically connected to the controller of the refrigerator 1. The position detection sensor 450 may transmit an electrical signal corresponding to the position of the door pusher 420 to the controller. When the position detection sensor 450 detects that the door pusher 420 reaches the second pusher position P2, the position detection sensor 450 may output a corresponding electrical signal and transmit the electrical signal to the controller. When the controller receives the electrical signal indicating that the door pusher 420 reaches the second pusher position P2, the controller may control the power source 430 to allow the door pusher 420 to stop or to move to the first pusher position P1.

In addition, the controller 50 may determine whether the door pusher 420 reaches the second pusher position P2 using various methods, and control the power source 430 based on the determination.

For example, based on the position information of the rotor of the drive motor provided in the power source 430, the controller 50 may control the power source 430 to allow the door pusher 420 to move to the second pusher position P2, and when the door pusher 420 reaches the second pusher position P2, the controller may control the power source 430 to allow the door pusher 420 to stop or to return to the first pusher position P1.

For example, the power source 430 may include a step motor. In this case, based on the number of pulse signals input to the step motor, the controller 50 may control the power source 430 to allow the door pusher 420 to move to the second pusher position P2 and when the door pusher 420 reaches the second pusher position P2, the controller may control the power source 430 to allow the door pusher 420 to stop or to return to the first pusher position P1.

As illustrated in FIGS. 5 to 9, in one embodiment, when the door pusher 420 reaches the second pusher position P2, the door pusher 420 may stop the movement thereof by a mechanical structure.

For example, the door pusher 420 may include a stopper 424. The stopper 424 may be provided to prevent the door pusher 420 from moving further in the direction of pressing the door 30 when the door pusher 420 is located at a specific position with respect to the pusher case 410. As shown in FIGS. 8 and 9, when the door pusher 420 reaches the second pusher position P2, the stopper 424 may stop the door pusher 420 relative to the main body 10 and the pusher case 410.

For example, a distance between one end (e.g., roller 422 in contact with the door 30 of the door pusher 420 and the stopper 424 may be the same as a distance between the first pusher position P1 and the second pusher position P2. However, this may vary according to a distance between the door pusher 420 and the door 30 at the first pusher position P1, the position of the stopper 424, etc.

For example, the stopper 424 may be disposed on the movable rod 421. For example, the stopper 424 may be formed in the shape of a rib protruding from the movable rod 421. For example, the stopper 424 may protrude from the movable rod 421 in the vertical direction (Z).

For example, the stopper 424 may be provided to stop the movement of the door pusher 420 with respect to the pusher case 410 as the stopper 424 is locked to the pusher case 410 when the door pusher 420 moves.

Particularly, the pusher case 410 may include a case entrance and exit portion 410a through which the door pusher 420 moves and penetrates. The case entrance and exit portion 410a may be formed on one side of the pusher case 410 with respect to the direction in which the door pusher 420 is withdrawn from the pusher case 410 (e.g., the front side of the pusher case 410. The case entrance and exit portion 410a may have the shape of a hole connecting the inside and outside of the pusher case 410. The door pusher 420 may be provided to be withdrawn to the outside of the pusher case 410 or inserted into the inside of the pusher case 410 through the case entrance and exit portion 410a.

When the door pusher 420 is withdrawn from the pusher case 410, the stopper 424 may be provided to be locked to the case entrance and exit portion 410a. For example, the stopper 424 may be provided to be locked to the case entrance and exit portion 410a when the door pusher 420 reaches the second pusher position P2. When the stopper 424 is locked to the case entrance and exit portion 410a, the door pusher 420 may no longer move in the direction in which the door pusher 420 is withdrawn from the pusher case 410, and the door pusher 420 may stop.

The case entrance and exit portion 410a may include a locking portion 410b provided to allow the stopper 424 to be locked thereto. For example, the locking portion 410b may have the shape of a rib extending from the inner wall of the pusher case 410 toward the inside of the pusher case 410.

When the door pusher 420 reaches the second pusher position P2, the stopper 424 may be in contact with the locking portion in a direction parallel to the moving direction of the door pusher 420 (front and rear direction based on the drawings) so as to prevent the door pusher 420 from passing through the case entrance and exit portion 410a.

When the door pusher 420 moves in the direction of pressing the door 30, the movable rod 421 may pass through the case entrance and exit portion 410a without being locked to the locking portion 410b, but the stopper 424 may be locked to the locking portion 410b. Accordingly, the stopper 424 may not pass through the case entrance and exit portion 410a and thus the door pusher 420 may stop.

The configuration of the stopper 424 is not limited thereto, and the stopper 424 may be provided to locked to various configurations, which are disposed on various portions of the pusher case 410 or disposed on the inside of the pusher case 410, when the door pusher 420 moves to the second pusher position P2, so as to stop the door pusher 420.

However, when the stopper 424 is locked to the case entrance and exit portion 410a, the position of the door pusher 420 and the second pusher position P2 may be different from each other. For example, when the door pusher 420 is withdrawn from the pusher case 410, the door pusher 420 may reach the second pusher position P2 before the stopper 424 is locked to the case entrance and exit portion 410a. In this case, the controller may control the power source 430 to allow the door pusher 420 to stop or to return to the first pusher position P1 based on an output signal of the position detection sensor 450 corresponding to the fact that the door pusher 420 reaches the second pusher position P2. Even in this case, when the door pusher 420 is withdrawn further than the second pusher position P2 due to a control error or the like, the stopper 424 may prevent that the door pusher 420 is separated from the pusher case 410 through the case entrance and exit portion 410a.

The structure of the door opening device 400 described with reference to FIGS. 5 to 9 is an example of the structure of the door opening device that is included in the refrigerator according to the disclosure and configured to open the door, but the disclosure is not limited thereto.

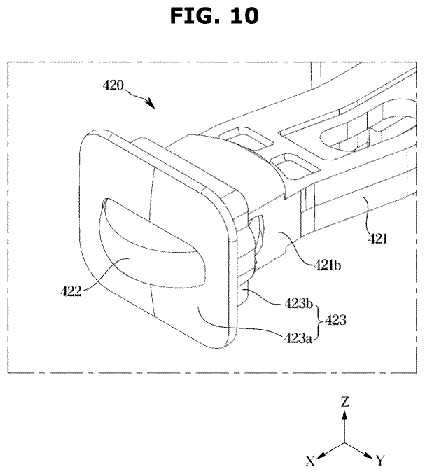

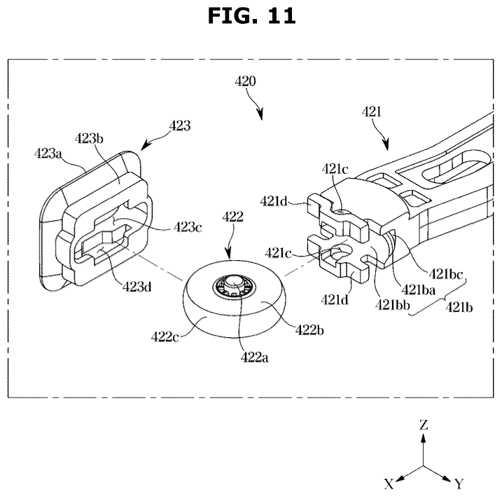

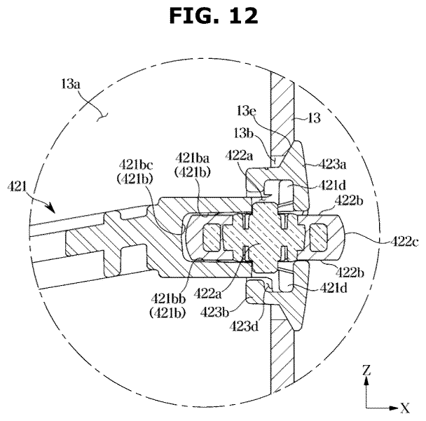

FIG. 10 is an enlarged view illustrating a part of the door pusher included in the door opening device of the refrigerator according to one embodiment of the disclosure. FIG. 11 is an exploded view illustrating some components of the door pusher included in the door opening device of the refrigerator according to one embodiment of the disclosure. FIG. 12 is a cross-sectional view illustrating a partial configuration of the refrigerator according to one embodiment of the disclosure.

Referring to FIGS. 10 to 12, the door opening device 400 of the refrigerator 1 according to an embodiment of the disclosure may include the moving rod 421 provided to be movable relative to the main body 10, and the push roller 422 provided on one side of the moving rod 421 to press the door 30.

As described above, the moving rod 421 may be provided to be movable between a first position, which is the position when the door pusher 420 is located at the first pusher position P1, and a second position, which is the position when the door pusher 420 is located at the second pusher position P2. That is, the moving rod 421 may be provided to be movable relative to the main body 10 between the first position and the second position to which the moving rod 421 moves from the first position in a direction that opens the door 30.

As described above, the push roller 422 may be provided to press the door 30 when the moving rod 421 moves from the first position toward the second position. The door 30 located at the closed position may be opened by being pressed by the push roller 422.

The push roller 422 may be coupled to the moving rod 421. The push roller 422 may be coupled to one side of the moving rod 421 in a direction toward the door 30. For example, the push roller 422 may be coupled to a front portion of the moving rod 421.

The push roller 422 may be provided to move together with the moving rod 421 when the moving rod 421 moves between the first position and the second position.

The push roller 422 may be rotatably coupled to the moving rod 421. Specifically, when the moving rod 421 moves from the first position toward the second position, the push roller 422 may rotate due to frictional force between the push roller 422 and the door 30 while pressing the door 30. That is, when the door opening device 400 opens the door 30, the push roller 422 may be provided to rotate relative to the moving rod 421 while pressing the door 30.

The push roller 422 may be provided to be rotatable about a rotation axis in a direction parallel to the extension direction of the rotation axis of the door 30. That is, the rotation axis of the push roller 422 and the rotation axis of the door 30 may be parallel to each other. For example, the push roller 422 may be provided to be rotatable about a rotation axis in the vertical direction (Z).

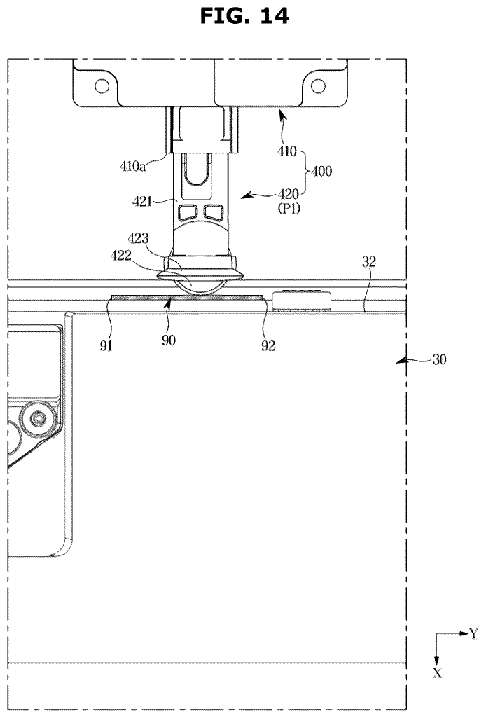

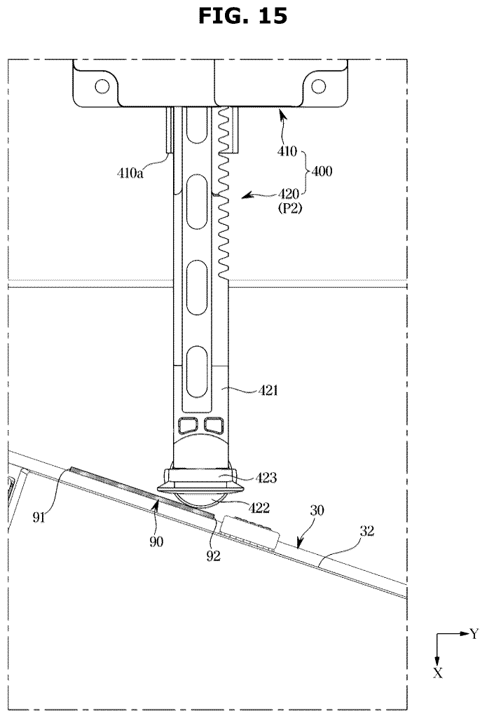

For example, the push roller 422 may, during rotation of the door 30 from the closed position toward the open position, rotate due to frictional force with the door 30 so that the push roller 422 may rotate in the same direction as the rotation direction of the door 30. Based on what is shown in FIGS. 14 and 15, the door 30 may be opened while rotating clockwise, and the push roller 422 may rotate clockwise when pressing the door 30.

For example, the push roller 422 may include a roller shaft 422a. The rotation axis of the push roller 422 may pass through the roller shaft 422a. The push roller 422 may rotate about the roller shaft 422a. The push roller 422 may be provided to be rotatable relative to the moving rod 421 about the roller shaft 422a.

The roller shaft 422a may extend parallel to the extension direction of the rotation axis of the door 30. For example, the roller shaft 422a may extend along the vertical direction (Z) of the refrigerator 1.

For example, the roller shaft 422a may have a substantially cylindrical shape, in which case the rotation axis of the push roller 422 may coincide with a central axis of the roller shaft 422a.

For example, the push roller 422 may have a substantially disc shape or cylindrical shape with the roller shaft 422a as the central axis.

For example, the push roller 422 may include a pair of base surfaces 422b and an outer circumferential surface 422c formed between the pair of base surfaces 422b. The outer circumferential surface 422c of the push roller 422 may connect the pair of base surfaces 422b.

The pair of base surfaces 422b may be arranged to face each other in a direction parallel to the rotation axis of the push roller 422. The rotation axis of the push roller 422 may pass through the pair of base surfaces 422b. The base surfaces 422b of the push roller 422 may be penetrated by the roller shaft 422a.

For example, each of the pair of base surfaces 422b may have a substantially planar shape. For example, each of the pair of base surfaces 422b may have a substantially circular shape centered on the rotation axis of the push roller 422.

For example, the roller shaft 422a may have an extension length longer than the distance between the pair of base surfaces 422b. For example, the roller shaft 422a may extend further upward than the base surface 422b located on the upper side among the pair of base surfaces 422b. For example, the roller shaft 422a may extend further downward than the base surface 422b located on the lower side among the pair of base surfaces 422b.

The outer circumferential surface 422c of the push roller 422 may be provided to press the door 30. That is, when opening the door 30, the push roller 422 may press the door 30 using the outer circumferential surface 422c.

The outer circumferential surface 422c of the push roller 422 may be formed in a curved shape. For example, the outer circumferential surface 422c of the push roller 422 may have a substantially cylindrical shape centered on the rotation axis of the push roller 422. The outer circumferential surface 422c of the push roller 422 may extend in a direction parallel to the rotation axis of the push roller 422.

For example, the outer circumferential surface 422c of the push roller 422 may have a shape in which a central portion of the outer circumferential surface 422c is convex radially outward. That is, the outer circumferential surface 422c of the push roller 422 may be formed so that the distance from the rotation axis is shortest at the portions connected to each of the pair of base surfaces 422b and longest at the central portion.

However, the disclosure is not limited thereto, and the push roller 422 may have various shapes.

The moving rod 421 may include a roller support portion 421b provided to support the push roller 422. The roller support portion 421b may be provided on one side of the moving rod 421 in a direction for opening the door 30. The roller support portion 421b may be provided on one side of the moving rod 421 in a direction toward the door 30. The roller support portion 421b may be provided at an end of the moving rod 421. For example, the roller support portion 421b may be provided at the front portion of the moving rod 421. The roller support portion 421b may rotatably support the push roller 422.

The roller support portion 421b may be formed so that a portion of the push roller 422 may be insertable. The roller support portion 421b may have the shape of a groove into which a portion of the push roller 422 is inserted. As the push roller 422 rotates relative to the roller support portion 421b, the portion of the push roller 422 inserted into the roller support portion 421b may vary.

For example, the roller support portion 421b may include a first inner surface 421ba, a second inner surface 421bb opposed to the first inner surface 421ba, and a third inner surface 421bc connecting the first inner surface 421ba and the second inner surface 421bb. The portion of the push roller 422 may be inserted into a space formed by the first inner surface 421ba, the second inner surface 421bb, and the third inner surface 421bc. The roller support portion 421b may be formed with a side opposite to the third inner surface 421bc being open. The side of the roller support portion 421b opposite to the third inner surface 421bc may be the front side of the moving rod 421, as shown in FIGS. 11 and 12.

For example, the first inner surface 421ba of the roller support portion 421b may face one of the pair of base surfaces 422b of the push roller 422. The second inner surface 421bb of the roller support portion 421b may face the other of the pair of base surfaces 422b of the push roller 422. The third inner surface 421bc of the roller support portion 421b may face a portion of the outer circumferential surface 422c of the push roller 422.

For example, the first inner surface 421ba of the roller support portion 421b may be arranged parallel to the base surface 422b of the push roller 422. For example, the first inner surface 421ba of the roller support portion 421b may have a substantially flat planar shape.

For example, the second inner surface 421bb of the roller support portion 421b may be arranged parallel to the base surface 422b of the push roller 422. For example, the second inner surface 421bb of the roller support portion 421b may have a substantially flat planar shape.

For example, the third inner surface 421bc of the roller support portion 421b may be arranged parallel to a portion of the outer circumferential surface 422c of the push roller 422. For example, the third inner surface 421bc of the roller support portion 421b may have a curved shape. Furthermore, the third inner surface 421bc of the roller support portion 421b may have a shape in which the central portion is most concave.

For example, the first inner surface 421ba and the second inner surface 421bb of the roller support portion 421b may face each other in a direction parallel to the rotation axis of the push roller 422. The first inner surface 421ba and the second inner surface 421bb of the roller support portion 421b may face each other in a direction parallel to the rotation axis of the door 30. For example, the first inner surface 421ba and the second inner surface 421bb of the roller support portion 421b may face each other in the vertical direction (Z).

To prevent the push roller 422 from being interfered with by the roller support portion 421b when rotating, the third inner surface 421bc of the roller support portion 421b may be spaced apart from the outer circumferential surface 421c of the push roller 422. Most of the first inner surface 421ba and the second inner surface 421bb of the roller support portion 421b may each be spaced apart from the base surface 422b of the push roller 422. The first inner surface 421ba and the second inner surface 421bb of the roller support portion 421b may each contact only a portion of the base surface 422b to support the push roller 422. Alternatively, the first inner surface 421ba and the second inner surface 421bb of the roller support portion 421b may each be spaced apart from the entire area of the base surface 422b, in which case the push roller 422 may be supported by the roller support portion 421b only by the roller shaft 422a.

The push roller 422 may be coupled to the moving rod 421 by the roller shaft 422a. The roller shaft 422a may be connected to the moving rod 421. For example, the moving rod 421 may include a roller shaft hole 421c to which the roller shaft 422a is connected. The roller shaft 422a may be provided to be rotatable relative to the roller shaft hole 421c. The rotation axis of the push roller 422 may pass through the roller shaft hole 421c.

The roller shaft hole 421c may be provided in the roller support portion 421b of the moving rod 421. The roller shaft hole 421c may be formed at one end of the moving rod 421.

The roller shaft hole 421c may be provided to allow insertion of the roller shaft 422a. For example, the roller shaft hole 421c may be formed in a shape that passes through the roller support portion 421b so as to allow the roller shaft 422a to be inserted therein.

The roller shaft hole 421c may have a diameter larger than a diameter of the roller shaft 422a so that the roller shaft 422a may rotate smoothly. That is, there may be a separation space between an outer circumferential surface of the roller shaft 422a and an inner circumferential surface of the roller shaft hole 421c.

For example, a pair of roller shaft holes 421c may be formed in the roller support portion 421b. The pair of roller shaft holes 421c may be arranged to face each other in the direction in which the rotation axis of the push roller 422 extends. The pair of roller shaft holes 421c may be arranged to face each other in the direction of the rotation axis of the door 30. For example, the pair of roller shaft holes 421c may be arranged to face each other in the vertical direction (Z).

For example, one of the pair of roller shaft holes 421c may be provided on the first inner surface 421ba of the roller support portion 421b, and the other may be provided on the second inner surface 421bb of the roller support portion 421b.

However, alternatively, only a single roller shaft hole 421c may be formed in the moving rod 421.

With this structure, the push roller 422 may be provided to be rotatable relative to the moving rod 421 while being supported by the moving rod 421.

As such, the door pusher 420 of the door opening device 400 includes the push roller 422 that is rotatably provided relative to the moving rod 421 and is provided to press the door 30 when opening the door 30, thereby reducing friction with the door 30 and opening the door 30 more easily. Additionally, as the door pusher 420 of the door opening device 400 includes the push roller 422, wear or damage to components that may occur due to friction with the door 30 may be efficiently prevented.

As described above, the door pusher 420 may be withdrawn from the accommodating space 13a through the opening 13b formed in the main body 10, or may be inserted into the accommodating space 13a through the opening 13b. The door pusher 420 may be provided to allow the opening 13b to be inserted therearound. In other words, when the moving rod 421 moves from the first position to the second position, the door pusher 420 may be withdrawn from the accommodating space 13a through the opening 13b, and when moving from the second position to the first position, the door pusher 420 may be inserted into the accommodating space 13a through the opening 13b.

Therefore, the accommodating space 13a may be connected to the outside through the opening 13b. Therefore, it may be required to prevent external foreign substances from entering the accommodating space 13a through the opening 13b. Furthermore, as shown in FIGS. 5 to 9, etc., since the inside and outside of the pusher case 410 accommodated in the accommodating space 13a may be connected through the case entrance and exit portion 410a, it may be required to prevent external foreign substances from entering the pusher case 410 through the opening 13b and the case entrance and exit portion 410a.

Therefore, as described above, the door pusher 420 may include an opening cover 423. The opening cover 423 may be provided to prevent external foreign substances from entering through the opening 13b when the door pusher 420 is located at the first pusher position P1. Specifically, the opening cover 423 may be provided to cover the opening 13b when the door pusher 420 is located at the first pusher position P1. In other words, the opening cover 423 may be provided to cover the opening 13b when the moving rod 421 is located at the first position. In yet another expression, the opening cover 423 may be provided to cover the opening 13b when the moving rod 421 is inserted into the accommodating space 13a. Conversely, when the moving rod 421 moves from the first position to the second position, the opening cover 423 may open the opening 13b.

Specifically, the opening cover 423 may include a cover portion 423a provided to cover the opening 13b. The cover portion 423a may cover the opening 13b from the outside of the accommodating space 13a when the moving rod 421 is located at the first position. For example, the cover portion 423a may cover the opening 13b from the front. For example, the cover portion 423a may form the front surface of the opening cover 423.

For example, as shown in FIG. 12, the opening cover 423 may be provided to cover up to an outer peripheral portion of the opening 13b. In other words, the cover portion 423a may extend to cover up to the outer peripheral portion of the opening 13b when the moving rod 421 is located at the first position. The cover portion 423a may contact the outer peripheral portion of the opening 13b. That is, the width of the opening cover 423 may be greater than the width of the opening 13b. Due to this structure, the cover portion 423a may cover the opening 13b more efficiently.

The main body 10 may include an opening edge surface 13e formed along the edge of the opening 13b. That is, the top table 13 may include the opening edge surface 13e formed along the edge of the opening 13b. For example, the opening edge surface 13e may be arranged to face the door 30. The opening edge surface 13e may be arranged to face the outside of the accommodating space 13a.

The opening cover 423 may cover the opening edge surface 13e. Specifically, the cover portion 423a may cover the opening edge surface 13e. The cover portion 423a may contact the opening edge surface 13e.

For example, as shown in FIG. 12, the opening edge surface 13e may be formed to be inclined with respect to the vertical direction (Z). Specifically, the opening edge surface 13e may extend toward an inner side of the edge of the opening 13b as being directed toward the inside of the accommodating space 13a. As shown, the opening edge surface 13e may extend toward the inner side of the edge of the opening 13b as being directed toward the rear.

In this case, the cover portion 423a of the opening cover 423 may be formed so that one surface facing the opening edge surface 13e has a shape corresponding to the opening edge surface 13e. That is, the one surface of the cover portion 423a facing the opening edge surface 13e may include an inclined surface extending in a direction corresponding to the inclination direction of the opening edge surface 13e. Thereby, when the moving rod 421 moves from the second position to the first position, the opening edge surface 13e may more stably guide the position of the cover portion 423a. Additionally, the gap between the cover portion 423a and the opening edge surface 13e may be sealed more efficiently.

However, the shape of the cover portion 423a described above is only an example, and the spirit of the disclosure is not limited thereto.

The opening cover 423 may be provided to penetrate the opening 13b when the moving rod 421 is at the first position. Specifically, the opening cover 423 may include an extension portion 423b extending from the cover portion 423a. The extension portion 423b may extend from the cover portion 423a toward the accommodating space 13a by penetrating the opening 13b when the moving rod 421 is at the first position. For example, the extension portion 423b may extend rearward from the cover portion 423a.

The width of the extension portion 423b may be smaller than the width of the opening 13b. Thereby, when the moving rod 421 moves from the second position to the first position, the extension portion 423b may easily pass through the opening 13b and be inserted into the accommodating space 13a.

For example, the extension portion 423b may contact one side of the moving rod 421b. For example, the extension portion 423b may contact a portion of the push roller 422.

For example, the cover portion 423a and the extension portion 423b may be formed integrally, but are not limited thereto.

The opening cover 423 may be coupled to one side of the moving rod 421. Specifically, the opening cover 423 may be coupled to one side of the moving rod 421 to which h the push roller 422 is coupled. For example, the opening cover 423 may be coupled to the front end of the moving rod 421. The opening cover 423 may be coupled to the roller support portion 421b of the moving rod 421, or to at least a portion adjacent to the roller support portion 421b of the moving rod 421.

The opening cover 423 may be fixed to the moving rod 421. Therefore, when the moving rod 421 moves between the first position and the second position relative to the main body 10, the opening cover 423 may be provided to move together with the moving rod 421. That is, when the moving rod 421 moves between the first position and the second position, the moving rod 421, the push roller 422, and the opening cover 423 may move together.

For example, the opening cover 423 may be fitted to the moving rod 421. Specifically, the moving rod 421 may include a protrusion 421d protruding from the roller support portion 421b, and the opening cover 423 may include a coupling groove 423d provided for insertion of the protrusion 421d. The opening cover 423 may be coupled to the moving rod 421 as the protrusion 421d is inserted into the coupling groove 423d. Specifically, the protrusion 421d may be provided to be inserted into the coupling groove 423d so that the opening cover 423 is fitted to the moving rod 421. More specifically, the coupling groove 423d may be formed to surround the protrusion 421d. For example, the coupling groove 423d may contact the protrusion 421d in the front-rear direction (X). Additionally, for example, the coupling groove 423d may contact the protrusion 421d in the vertical direction (Z).

For example, the protrusion 421d may protrude from the roller support portion 421b in the vertical direction (Z). Additionally, the coupling groove 423d may be formed by being recessed from a roller penetration portion 423c, which is described later, in the vertical direction (Z). The protrusion 421d may have the shape of a rib formed at one end of the moving rod 421.

For example, the protrusion 421d may include a pair of protrusions 421d protruding from the roller support portions 421b in opposite directions (e.g., vertical direction). Additionally, the coupling groove 423d may include a pair of coupling grooves 423d recessed from the roller penetration portions 423c, which are described later, in opposite directions.

For example, the opening cover 423 may be formed of an elastic material such as rubber. Thereby, the opening cover 423 may be easily fitted to the moving rod 421 without a separate coupling member. Additionally, thereby, the opening cover 423 may more efficiently seal the opening 13b when the moving rod 421 is at the first position.

In a process of assembling and mounting each component of the door opening device 400 including the door pusher 420 to the main body 10, the manufacturer may install all parts of the door opening device 400 except the opening cover 423 in the main body 10, then pull an end portion of the door pusher 420 (for example, the push roller 422) through the opening 13b to withdraw it from the accommodating space 13a, and then fit the opening cover 423 to the end portion of the moving rod 421, thereby completing the assembly and installation of the product.

Since the push roller 422 needs to contact the door 30 and press the door 30 when the moving rod 421 moves from the first position to the second position, the push roller 422 may be arranged so that at least a portion thereof is closer to a side in the direction of pressing the door 30 (i.e., the front side) than other components of the door pusher 420. The push roller 422 may be provided so that at least a portion thereof is located in front of the opening cover 423.

Therefore, when the door pusher 420 is located at the first pusher position P1 and the opening cover 423 covers the opening 13b, at least a portion of the push roller 422 may be located in front of the opening 13b. That is, when the moving rod 421 is located at the first position, at least a portion of the push roller 422 may be located outside the accommodating space 13a.

For example, when the moving rod 421 is located at the first position, the push roller 422 may be arranged to penetrate the opening 13b so that a portion is disposed outside the accommodating space 13a and another portion is disposed inside the accommodating space 13a.

Since the opening cover 423 covers the opening 13b when the moving rod 421 is located at the first position, the push roller 422 may be arranged to penetrate the opening 13b together with the opening cover 423. As described above, since the push roller 422 and the opening cover 423 are provided to move together with the moving rod 421, the push roller 422 may be arranged to penetrate the opening cover 423 even in cases other than when the moving rod 421 is at the first position.

Specifically, the opening cover 423 may include a roller penetration portion 423c provided for the push roller 422 to penetrate. The opening cover 423 may be formed in a shape surrounding the roller penetration portion 423c.

For example, the roller penetration portion 423c may be formed to pass through the opening cover 423 in a direction parallel to the direction in which the push roller 422 presses the door 30. As shown in the drawings, the roller penetration portion 423c may be formed to pass through the opening cover 423 in the front-rear direction (X). The push roller 422 may penetrate the roller penetration portion 423c in the front-rear direction (X). For example, the roller penetration portion 423c may be formed in a shape corresponding to a portion of the push roller 422 located inside the roller penetration portion 423c.

The opening cover 423 may be provided to surround a portion of the push roller 422. The opening cover 423 may be provided to surround a portion of the push roller 422 penetrating the roller penetration portion 423c. For example, the opening cover 423 may be provided to contact a portion of the pair of base surfaces 422b and a portion of the outer circumferential surface 422c of the push roller 422.

However, the disclosure is not limited thereto, and for example, the push roller 422 may be entirely located outside the accommodating space 13a even when the moving rod 421 is located at the first position, in which case the push roller 422 may be entirely located in front of the opening cover 423, and therefore the opening cover 423 may not be penetrated by the push roller 422.

As such, the door pusher 420 includes the opening cover 423 provided to cover the opening 13b when the moving rod 421 is at the first position, thereby efficiently preventing foreign substances from entering the inside of the top table 13 or the components of the refrigerator 1.

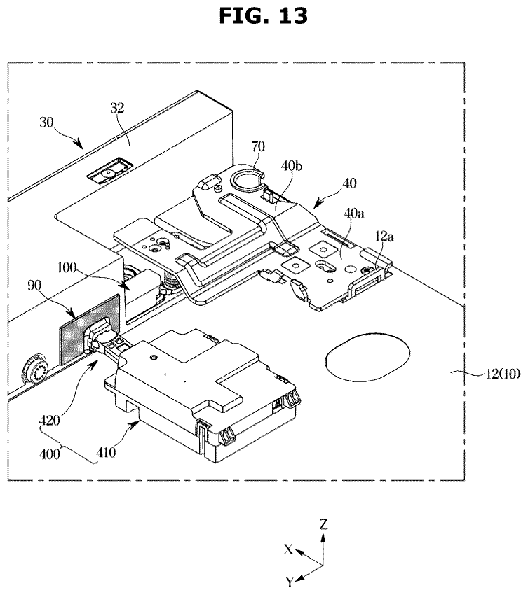

FIG. 13 is a rear view illustrating a partial configuration of the refrigerator according to one embodiment of the disclosure. FIG. 14 is a view of the refrigerator according to one embodiment of the disclosure when the door pusher is located at a first pusher position. FIG. 15 is a view of the refrigerator according to one embodiment of the disclosure when the door pusher is located at a second pusher position.

Referring to FIGS. 13 to 15, the refrigerator 1 according to an embodiment of the disclosure may further include a plate 90 provided on one side of the door 30 pressed by the door pusher 420. The door pusher 420 may open the door 30 by pressing the plate 90. The plate 90 may be provided to prevent the outer surface of the door 30 from being worn when the door 30 is pressed by the door pusher 420.

When the moving rod 421 moves from the first position to the second position, the push roller 422 may be provided to press the plate 90. When the moving rod 421 moves from the first position to the second position, the push roller 422 may contact the plate 90 and rotate relative to the moving rod 421.

The plate 90 may be attached to one surface of the door 30 facing the push roller 422 when the door 30 is in the closed position. As shown, the plate 90 may be attached to the rear surface of the door 30.

The plate 90 may be attached to a portion of the door 30 pressed by the door pusher 420. For example, the door pusher 420 may be provided to press the door cap 32 when opening the door 30, and the plate 90 may be attached to one surface of the door cap 32.

The plate 90 may be coupled to the door 30 in various ways. For example, the plate 90 may be coupled to the door 30 by adhesive. Alternatively, for example, the plate 90 may be coupled to the door 30 by a separate fastening component such as a screw. Alternatively, for example, the plate 90 may have a coupling structure such as a hook and be coupled to the door 30. The manner in which the plate 90 is coupled to the door 30 is not limited thereto.

A portion (for example, the door frame 31, the door cap 32, etc.) forming an outer surface of the door 30 and the plate 90 may be formed of different materials from each other. Specifically, when the portion forming the outer surface of the door 30 is formed of a first material and the plate 90 is formed of a second material, the second material may include a material having greater properties such as wear resistance, rigidity, hardness, etc. than the first material. For example, the plate 90 may be formed of a material having greater properties such as wear resistance, rigidity, hardness, etc. than the material of the door cap 32.

For example, the plate 90 may be formed of a highly rigid and wear-resistant material including polyoxymethylene (POM) material or metal material such as steel.

As shown in FIGS. 14 and 15, the plate 90 may extend along an area in which the push roller 422 moves relatively with respect to the door 30 when the push roller 422 presses the door 30. The plate 90 may extend in a direction perpendicular to the rotation axis of the door 30. For example, the plate 90 may extend in a horizontal direction.

Referring to FIGS. 14 and 15, the plate 90 may include a first end 91 and a second end 92. The first end 91 and the second end 92 may be provided at positions opposite to each other. The first end 91 and the second end 92 may be positioned parallel to each other in the horizontal direction. The plate 90 may extend between the first end 91 and the second end 92. The first end 91 of the plate 90 may be positioned in a direction adjacent to the rotation axis of the door 30 with respect to the second end 92. The distance between the first end 91 and the rotation axis of the door 30 may be shorter than the distance between the second end 92 and the rotation axis of the door 30.

While the door pusher 420 presses the door 30, the push roller 422 may be provided to continuously contact the plate 90. That is, while the door pusher 420 presses the door 30, the push roller 422 may be provided to continuously contact points between the first end 91 and the second end 92 of the plate 90. In this case, as the door 30 rotates from the closed position toward the open position, a point on the plate 90 contacted by the push roller 422 may move from a side of the first end 91 toward a side of the second end 92. That is, a point at which the push roller 422 and the plate 90 contact may become farther from the rotation axis of the door 30 as the angle at which the door 30 rotates toward the open position increases. When the door pusher 420 moves from the first pusher position P1 toward the second pusher position P2, a point on the plate 90 contacted by the push roller 422 when the door pusher 420 reaches the second pusher position P2 (hereinafter referred to as ‘contact end point’) may be closer to the second end 92 of the plate 90 than a point on the plate 90 initially contacted by the push roller 422 (hereinafter referred to as ‘contact start point’).

The contact start point on the plate 90 may be at least a point substantially coinciding with the first end 91 or a point located between the first end 91 and the second end 92. The contact end point on the plate 90 may be at least a point substantially coinciding with the second end 92 or a point located between the first end 91 and the second end 92.

A distance between the first end 91 and the second end 92 of the plate 90, that is, an extension distance of the plate 90, may increase as a total distance (i.e., the distance between the first pusher position P1 and the second pusher position P2) that the door pusher 420 moves while pressing the door 30 increases. Additionally, the extension distance of the plate 90 may increase as a total angle through which the door 30 rotates while the door pusher 420 presses the door 30 increases.

As such, the plate 90 is provided on one surface of the door 30 pressed by the door pusher 420, thereby preventing wear on the door 30 due to friction with the door pusher 420.

For example, the plate 90 may be provided to be detachable from the door 30. That is, the plate 90 may be a component that may be separated from the door 30 and replaced. In such a case, when the plate 90 is worn as the operation of the door opening device 400 is repeated, the user may replace only the plate 90, thereby reducing the repair cost of the product.

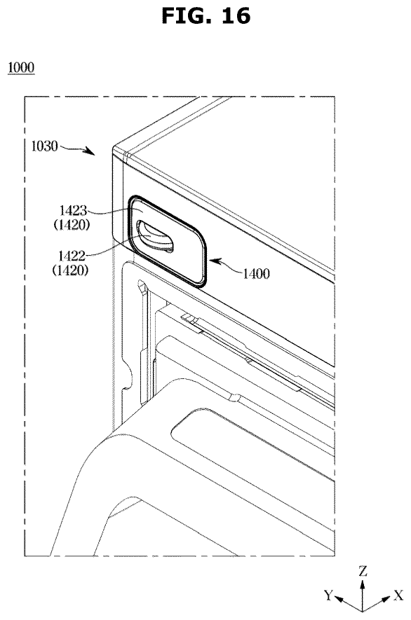

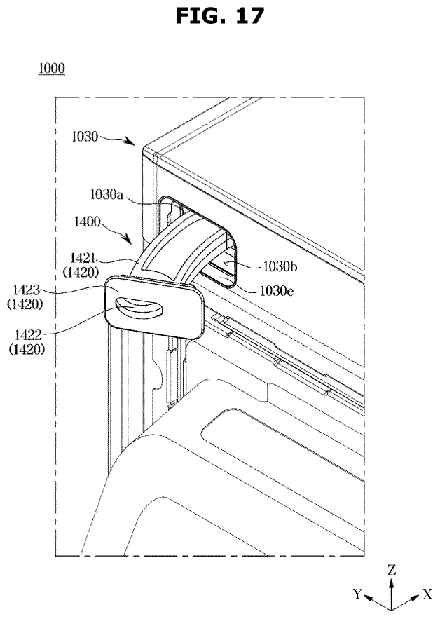

FIG. 16 is a view illustrating a door and a door opening device of a refrigerator according to one embodiment of the disclosure when a door pusher is located at a first pusher position in. FIG. 17 is a view illustrating the door and the door opening device of the refrigerator according to one embodiment of the disclosure when the door pusher is located at a second pusher position.

In describing the components of the refrigerator 1 according to an embodiment of the disclosure with reference to FIGS. 16 and 17, components corresponding to those of the refrigerator 1000 shown in the embodiment of FIGS. 1 to 15 may be given the same reference numerals and descriptions thereof may be omitted.

Referring to FIGS. 16 and 17, the refrigerator 1000 according to an embodiment of the disclosure may include a main body (10, see the previous embodiment) forming a storage compartment (20, see the previous embodiment), a door 1030 provided to open and close the main body 10, and a door opening device 1400 mounted on the door 1030.

Detailed descriptions of the storage compartment 20, the main body 10, and the door 1030 are omitted.

The door opening device 1400 may be provided to open the door 1030. The door opening device 1400 may be mounted on the door 1030 and provided to open the door 1030 by pressing the main body 10 and thereby opening the door 1030 by a reaction force generated therefrom.

The door 1030 may include an accommodating space 1030a formed to accommodate the door opening device 1400, and an opening 1030b formed on one side of the accommodating space 1030a. The accommodating space 1030a may be formed inside the door 1030. The accommodating space 1030a may be connected to the outside of the door 1030 through the opening 1030b.

For example, the accommodating space 1030a may be formed in an upper portion of the door 1030. For example, the accommodating space 1030a may be formed inside an upper door cap of the door 1030.

For example, the opening 1030b may be formed on a rear surface of the door 1030 (one surface of the door 1030 facing the main body 10 when the door 1030 is in the closed position).

The door opening device 1400 may include a body pusher 1420 provided to be movable relative to the door 1030 and provided to press the main body 10 when opening the door 1030. For example, the body pusher 1420 may be provided to press the front surface of the main body 10 (one surface of the main body 10 facing the door 1030 when the door 1030 is in the closed position). For example, the body pusher 1420 may be provided to press the front surface of the top table 13.

The body pusher 1420 may be provided to be movable relative to the accommodating space 1030a. The body pusher 1420 may be provided to be withdrawn from the accommodating space 1030a through the opening 1030b (refer to FIG. 17 or to be inserted into the accommodating space 1030a through the opening 1030b (refer to FIG. 16. The body pusher 1420 may press the main body 10 while being withdrawn from the accommodating space 1030a through the opening 1030b. The body pusher 1420 may move rearward through the opening 1030b and press the main body 10.

The body pusher 1420 may include a moving lever 1421. The moving lever 1421 may be provided to be movable relative to the main body 10. The moving lever 1421 may be provided to be movable relative to the accommodating space 1030a. The moving lever 1421 may be provided to be withdrawn from the accommodating space 1030a through the opening 1030b or to be inserted into the accommodating space 1030a through the opening 1030b. That is, the moving lever 1421 may be provided to move relative to the accommodating space 1030a while penetrating the opening 1030b.

For example, as will be described later, the moving lever 1421 may be provided to be rotatable relative to the accommodating space 1030a. The moving lever 1421 may be withdrawn from or inserted into the accommodating space 1030a while rotating relative to the accommodating space 1030a.

The body pusher 1420 may include a push roller 1422. The push roller 1422 may be provided to press the main body 10. Specifically, when the door opening device 1400 opens the door 1030, the push roller 1422 may be provided to press the main body 10. The push roller 1422 may be provided to press the main body 10 when the moving lever 1421 moves in a direction in which the moving lever 1421 is withdrawn from the accommodating space 1030a.

The push roller 1422 may be coupled to one side of the moving lever 1421. Specifically, the push roller 1422 may be coupled to one side of the moving lever 1421 in a direction of pressing the door 30. The push roller 1422 may be fixed to the moving lever 1421 and provided to move together with the moving lever 1421 when the moving lever 1421 moves.

The push roller 1422 may be provided to be rotatable relative to the moving lever 1421. The push roller 1422 may be rotatably coupled to one side of the moving lever 1421. When the door opening device 1400 opens the door 30, the push roller 1422 may be provided to rotate relative to the moving lever 1421 while pressing the main body 10.

For example, the push roller 1422 may rotate about a rotation axis in a direction parallel to the rotation axis of the door 1030. For example, the push roller 1422 may rotate about a rotation axis in a direction parallel to the rotation axis of the moving lever 1421. For example, the push roller 1422 may rotate about a rotation axis in the vertical direction (Z) of the refrigerator 1000.

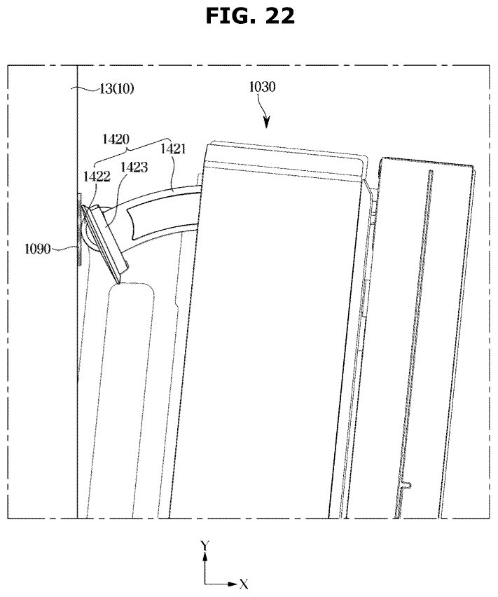

When the moving lever 1421 moves in a direction of being withdrawn from the accommodating space 1030a, the push roller 1422 may press one surface of the main body 10, and in this case, the push roller 1422 may rotate relative to the moving lever 1421 due to frictional force between the main body 10 and the push roller 1422. For example, based on what is shown in FIG. 22, when the push roller 1422 presses the main body 10, the push roller 1422 may rotate clockwise relative to the moving lever 1421. As shown in FIG. 22, the rotation direction of the moving lever 1421 relative to the door 1030 and the rotation direction of the push roller 1422 relative to the moving lever 1421 may be opposite to each other.

As such, the body pusher 1420 includes the push roller 1422 to reduce friction between the push roller 1422 and the main body 10. Thereby, the body pusher 1420 may open the door 1030 more easily. Additionally, the push roller 1422 may efficiently prevent wear or other damage to components such as the door 30.

The body pusher 1420 may include an opening cover 1423. The opening cover 1423 may be coupled to one side of the moving lever 1421. The opening cover 1423 may be coupled to one side of the moving lever 1421 to which the push roller 1422 is mounted.

The opening cover 1423 may be provided to cover the opening 1030b when the moving lever 1421 is inserted into the accommodating space 1030a. Conversely, the opening cover 1423 may be provided to open the opening 1030b when the moving lever 1421 is withdrawn from the accommodating space 1030a.

The opening cover 1423 may be provided to seal the opening 1030b when the moving lever 1421 is inserted into the accommodating space 1030a. For example, the opening cover 1423 may be formed of an elastic material such as rubber so that it may efficiently seal the opening 1030b.

Thereby, it is possible to efficiently prevent external foreign substances from entering the accommodating space 1030a of the door 1030 or components therein through the opening 1030b.

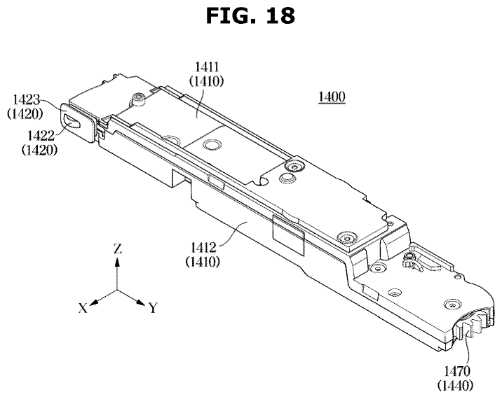

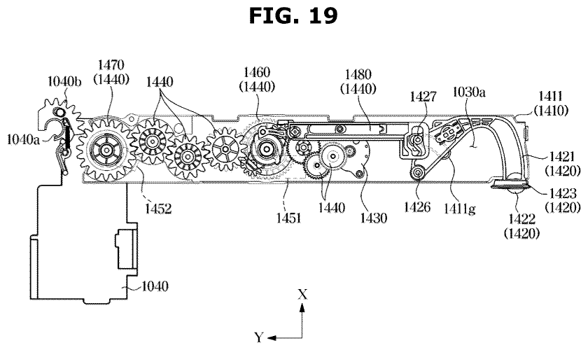

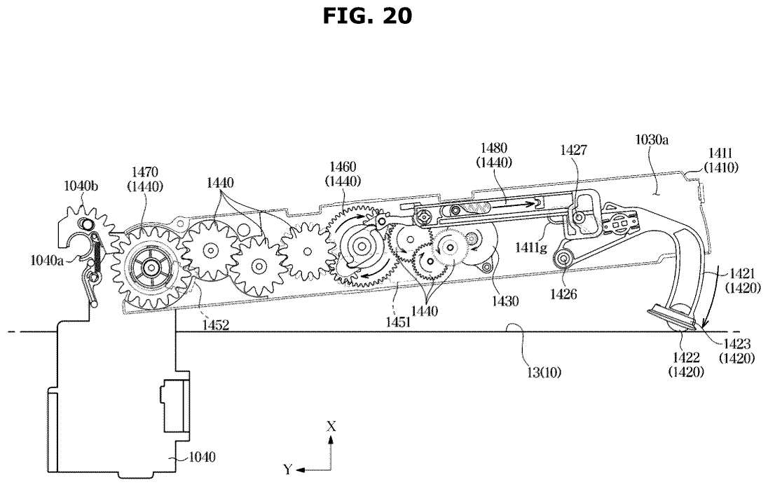

FIG. 18 is a perspective view illustrating the door opening device of the refrigerator according to one embodiment of the disclosure. FIG. 19 is a bottom view illustrating the door opening device of the refrigerator according to one embodiment of the disclosure. FIG. 20 is a bottom view illustrating a state in which the door opening device opens the door in the refrigerator according to one embodiment of the disclosure.

Referring to FIGS. 18 to 20, the door opening device 1400 of the refrigerator 1000 according to an embodiment of the disclosure may include a pusher case 1410. The pusher case 1410 may be accommodated in the door 1030. The pusher case 1410 may be mounted on the door 1030. The pusher case 1410 may be fixed to the door 1030.

The pusher case 1410 may form the exterior of the door opening device 1400. Various components of the door opening device 1400 may be accommodated inside the pusher case 1410.

For example, the pusher case 1410 may include a first pusher case 1411 and a second pusher case 1412. The first pusher case 1411 and the second pusher case 1412 may be coupled together to constitute a single pusher case 1410. Between the first pusher case 1411 and the second pusher case 1412, an accommodating space may be formed in which various components of the door opening device 1400 are accommodated.

For example, an opening through which the moving lever 1421 penetrates and is movably provided may be formed on one side of the pusher case 1410. For example, an opening that is open so that a terminal gear 1470 described later may be connected with a hinge gear 1040b may be formed on another side of the pusher case 1410.

The body pusher 1420 may be provided to be movable relative to the pusher case 1410. The moving lever 1421 may be provided to be movable relative to the pusher case 1410.

Hereinafter, the structure and operation of the door opening device 1400 will be described with an example.

In the embodiment shown in FIGS. 18 to 20, the door opening device 1400 may be configured not only to open the door 1030 but also to close the door 1030. In this aspect, the door opening device 1400 may be referred to as a ‘door opening and closing device 1400’, but in this document, it is referred to as a door opening device 1400 for convenience.

The door 1030 may be provided to be rotatable about a hinge 1040 fixed to the main body 10. The hinge 1040 may include a hinge shaft 1040a through which the rotation axis of the door 1030 passes and which maintains a stationary position relative to the main body 10, and a hinge gear 1040b coupled to the hinge shaft 1040a.

The door opening device 1400 may include a drive motor 1430 that generates power required for opening and closing the door 1030. The drive motor 1430 may be electrically connected to the controller of the refrigerator 1000.

The door opening device 1400 may include a plurality of power transmission members 1440 provided to transmit power from the drive motor 1430. For example, the plurality of power transmission members 1440 may include a plurality of gears, a slider 1480, and the like.

The power transmission member 1440 may include a center gear 1460. The center gear 1460 may receive power from the drive motor 1430 through the power transmission members 1440 connected to the drive motor 1430 and rotate.

The power transmission members 1440 located on a side in which the drive motor 1430is located and the power transmission members 1440 located on a side in which the hinge 1040 is located with respect to the center gear 1460 may be selectively connected or disconnected.

When the power transmission members 1440 located on the side of the drive motor 1430 and the power transmission members 1440 located on the side of the hinge 1040 are connected, power from the drive motor 1430 may be transmitted to the power transmission members 1440 on the side of the hinge 1040 through the power transmission members 1440 on the side of the drive motor 1430 and the center gear 1460. When power is transmitted to the terminal gear 1470 provided to rotate in engagement with the hinge gear 1040b, the door 1030 may rotate toward the open position or the closed position by the rotation of the terminal gear 1470 relative to the hinge gear 1040b.

Alternatively, when the power transmission members 1440 located on the side of the drive motor 1430 and the power transmission members 1440 located on the side of the hinge 1040 with respect to the center gear 1460 are disconnected, power from the drive motor 1430 may be transmitted to the center gear 1460 but may not be transmitted to the gears on the side of the hinge 1040.

When a door opening signal is input while the door 1030 is closed, the drive motor 1430 may generate power. In this case, the power transmission members 1440 located on the side of the drive motor 1430 and the power transmission members 1440 located on the side of the hinge 1040 with respect to the center gear 1460 may be disconnected from each other.

When the power transmission members 1440 located on the side of the drive motor 1430 and the power transmission members 1440 located on the side of the hinge 1040 are disconnected from each other, power generated by the drive motor 1430 may be transmitted to the center gear 1460. The power transmitted to the center gear 1460 may be transmitted to a slider 1480 provided to be slidably movable relative to the pusher case 1410. For example, the slider 1480 may be connected to the pusher case 1410 by an elastic spring.

The slider 1480 may receive the power generated by the drive motor 1430 through power transmission members such as the center gear 1460 and gears engaged therewith and slide. As shown in FIG. 20, as the slider 1480 slides toward the moving lever 1421, the slider 1480 may transmit the power from the drive motor 1430 to the moving lever 1421. Specifically, when the slider 1480 slides toward the moving lever 1421, a coupling protrusion 1427 of the moving lever 1421 may be pressed. Inside the pusher case 1410, a guide groove 1411g) that is fixed to the pusher case 1410 and guides the movement of the coupling protrusion 1427 may be provided, and the coupling protrusion 1427 may be inserted into the guide groove 1411g) and provided to be movable along the guide groove 1411g).

When the coupling protrusion 1427 is pressed, as shown in FIG. 20, the coupling protrusion 1427 may move along the guide groove 1411g), and the moving lever 1421 may rotate about a rotation axis 1426 relative to the pusher case 1411. Thereby, the moving lever 1421 may rotate relative to the accommodating space 1030a and be withdrawn from the accommodating space 1030a as shown in FIG. 20, and may press the main body 10.

When the moving lever 1421 presses the main body 10, as shown in FIG. 20, the door 1030 may rotate by a predetermined angle in the opening direction.

Thereafter, when the door 1030 is rotated by the predetermined angle from the closed position by the body pusher 1420, and the drive motor 1430 continues to generate power in the same direction, the power transmission members 1440 located on the side of the drive motor 1430 and the power transmission members 1440 located on the side of the hinge 1040 with respect to the center gear 1460 may be connected to each other. In this case, the power generated by the drive motor 1430 may be transmitted to the terminal gear 1470 through the power transmission members 1440 on the side of the hinge 1040 side, and as the terminal gear 1470 engages with the hinge gear 1040b, the door 1030 may further rotate toward the open position. Thereby, the door 1030 may be rotated to a fully open position.

In this process, the slider 1480 may be restored to the position before withdraw of the moving lever 1421 from the accommodating space 1030a. Thereby, the moving lever 1421 may rotate relative to the pusher case 1410 and be inserted back into the accommodating space 1030a.

When a door closing signal for rotating the door 1030 to the closed position is input while the door 1030 is open, the drive motor 1430 may generate power in a direction opposite to a direction in which the drive motor 1430 generate power to open the door 1030. In this case, the power transmission members 1440 located on the side of the drive motor 1430 and the power transmission members 1440 located on the side of the hinge 1040 with respect to the center gear 1460 may be in a connected state, and the power generated by the drive motor 1430 may be transmitted to the terminal gear 1470 through the power transmission members 1440 on the side of the hinge 1040. As the terminal gear 1470 engages with the hinge gear 1040b, the door 1030 may rotate toward the closed position. Thereby, the door 1030 may be rotated to the closed position.

For example, the door opening device 1400 may include a gear position detection sensor 1451 provided to detect the rotation angle and/or position of gears such as the center gear 1440. Additionally, for example, the door opening device 1400 may include a door position sensor 1452 provided to detect the rotation angle and/or position of the terminal gear 1470. Thereby, the controller of the refrigerator 1000 may control the operation of the door opening device 1400 more precisely.

As such, the refrigerator 1000 may open the door 1030 by including the door opening device 1400 including the body pusher 1420.

The structure of the door opening device 1400 described above with reference to FIGS. 18 to 20 is merely an example of a structure that a door opening device included in a refrigerator according to the spirit of the disclosure and provided to open a door may have, and the spirit of the disclosure is not limited thereto.

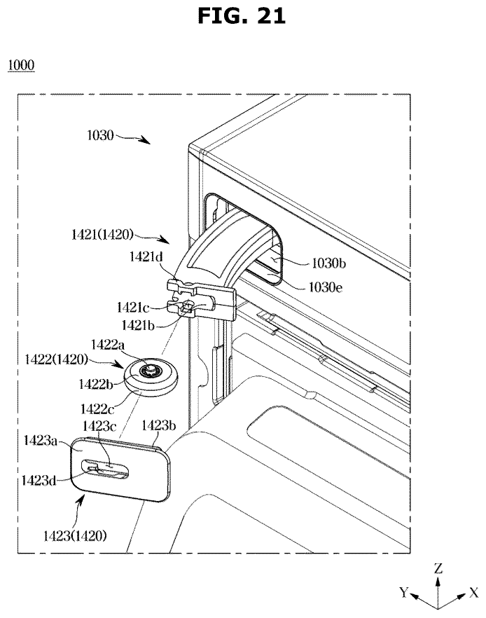

FIG. 21 is an exploded view illustrating some components of the refrigerator according to one embodiment of the disclosure.

Referring to FIG. 21, in the door opening device 1400 of the refrigerator 1000 according to an embodiment of the disclosure, the push roller 1422 may be rotatably mounted on the moving rod 1421.

The push roller 1422 may be provided to be rotatable about a rotation axis in a direction parallel to the extension direction of the rotation axis of the door 1030.

For example, the push roller 1422 may include a roller shaft 1422a. The rotation axis of the push roller 1422 may pass through the roller shaft 1422a. The push roller 1422 may rotate about the roller shaft 1422a. The push roller 1422 may be provided to be rotatable relative to the moving lever 1421 about the roller shaft 1422a.

The roller shaft 1422a may extend parallel to the extension direction of the rotation axis of the door 1030. For example, the roller shaft 1422a may extend along the vertical direction (Z) of the refrigerator 1000.

For example, the push roller 1422 may have a substantially disc shape or cylindrical shape with the roller shaft 1422a as the central axis.

The push roller 1422 may be connected to the moving lever 1421 through the roller shaft 1422a. The moving lever 1421 may include a roller shaft hole 1421c, and the roller shaft 1422a may be inserted into the roller shaft hole 1421c.

For example, the push roller 1422 may include a pair of base surfaces 1422b and an outer circumferential surface 1422c formed between the pair of base surfaces 1422b. The outer circumferential surface 1422c of the push roller 1422 may connect the pair of base surfaces 1422b.

The features of the structure of the push roller 1422 correspond to the push roller 422 described in the previous embodiment, so detailed description is omitted.

The moving lever 1421 may include a roller support portion 1421b provided to support the push roller 1422. The roller support portion 1421b may be provided on one side of the moving lever 1421 in the direction of opening the door 1030. The roller support portion 1421b may be formed so that a portion of the push roller 1422 may be inserted thereinto. The roller support portion 1421b may have the shape of a groove into which a portion of the push roller 1422 is inserted. The above described roller shaft hole 1421c may be formed to pass through the roller support portion 1421b.

The description of the roller support portion 1421b of the moving lever 1421 corresponds to the roller support portion 1421b described in the previous embodiment, so detailed description is omitted.

With this structure, the push roller 1422 may be supported by the moving lever 1421 and be rotatably provided with respect to the moving lever 1421.

As described above, the body pusher 1420 may include an opening cover 1423.

Specifically, the opening cover 1423 may include a cover portion 1423a provided to cover the opening 1030b. The cover portion 423a may cover the opening 1030b from the outside of the accommodating space 1030a when the moving lever 1421 is located within the accommodating space 1030a. For example, the cover portion 1423a may cover the opening 1030b from the rear.

For example, the opening cover 1423 may be provided to cover up to an outer peripheral portion of the opening 1030b. In other words, the cover portion 1423a may extend to cover up to the outer peripheral portion of the opening 1030b when the moving lever 1421 is located at a position inserted into the accommodating space 1030a.

The door 1030 may include an opening edge surface 1030e formed along the edge of the opening 1030b. For example, the opening edge surface 1030e may be arranged to face the main body 10. The opening edge surface 1030e may be arranged to face the outside of the accommodating space 1030a.

The opening cover 1423 may cover the opening edge surface 1030e. Specifically, the cover portion 1423a may cover the opening edge surface 1030e. The cover portion 1423a may contact the opening edge surface 1030e.

The features of the structure of the cover portion 1423a correspond to the cover portion 423a described in the previous embodiment, so detailed description is omitted.

The opening cover 1423 may be provided to penetrate the opening 1030b when the moving lever 1421 is at a position inserted into the accommodating space 1030a. Specifically, the opening cover 1423 may include an extension portion 1423b extending from the cover portion 1423a. The extension portion 1423b may extend from the cover portion 1423a toward the accommodating space 1030a by penetrating the opening 1030b when the moving lever 1421 is at the position inserted into the accommodating space 1030a.

The features of the structure of the extension portion 1423b correspond to the extension portion 423b described in the previous embodiment, so detailed description is omitted.

For example, the opening cover 1423 may be fitted to the moving lever 1421. Specifically, the moving lever 1421 may include a protrusion 1421d protruding from the roller support portion 1421b, and the opening cover 1423 may include a coupling groove 1423d provided for insertion of the protrusion 1421d. The opening cover 1423 may be coupled to the moving lever 1421 as the protrusion 421d is inserted into the coupling groove 1423d. Specifically, the protrusion 1421d may be inserted into the coupling groove 1423d so that the opening cover 1423 is fitted to the moving lever 1421. More specifically, the coupling groove 1423d may be formed to surround the protrusion 1421d.

The features of the structure of the protrusion 1421d and the coupling groove 1423d correspond to the protrusion 421d and the coupling groove 423d described in the previous embodiment, so detailed description is omitted.

When the opening cover 1423 covers the opening 1030b, at least a portion of the push roller 1422 may be located outside the accommodating space 1030a.

For example, when the moving lever 1421 is located within the accommodating space 1030a, the push roller 1422 may be arranged to penetrate the opening 1030b.

For example, the push roller 1422 may be arranged to penetrate the opening cover 1423. The opening cover 1423 may include a roller penetration portion 1423c provided for the push roller 1422 to penetrate. The opening cover 1423 may be formed in a shape surrounding the roller penetration portion 1423c.

The opening cover 1423 may be provided to surround a portion of the push roller 1422.

FIG. 22 is a top view illustrating a state in which the door opening device opens the door in the refrigerator according to one embodiment of the disclosure.

Referring to FIG. 22, the refrigerator 1000 according to an embodiment of the disclosure may further include a plate 1090 provided on one side of the main body 10 pressed by the body pusher 1420. The body pusher 1420 may open the door 1030 by pressing the plate 1090. The plate 1090 may be provided to prevent the outer surface of the main body 10 from being worn when the main body 10 is pressed by the body pusher 1420.

The plate 1090 may be attached to one surface of the main body 10 facing the push roller 1422 when the door 1030 closes the storage compartment 20. For example, the plate 1090 may be attached to one surface of the top table 13.

When the moving lever 1421 is withdrawn from the accommodating space 1030a, the push roller 1422 may be provided to press the plate 1090.

The plate 1090 may extend along an area in which the push roller 1422 moves relatively with respect to the main body 10 when the push roller 1422 presses the main body 10. The plate 1090 may extend in a direction perpendicular to the rotation axis of the door 1030. For example, the plate 1090 may extend in a horizontal direction.

As such, the plate 1090 is provided on the main body 10 pressed by the body pusher 1420, thereby preventing wear due to friction with the body pusher 1420.

A refrigerator 1 according to an embodiment of the disclosure may include a main body 10 forming a storage compartment 20, a door 30 configured to open and close the storage compartment 20, and a door opening device 400 mounted on the main body 10 and configured to open the door 30. The door opening device 400 may include a moving rod 421 configured to be movable relative to the main body 10 between a first position and a second position to which the moving rod 421 moves from the first position in a direction in which the door 30 is opened, and a push roller 422 rotatably coupled to one side of the moving rod 421 so as to be rotatable relative to the moving rod 421, the push roller 422 being configured to press the door 30 and rotate relative to the moving rod 421 when the moving rod 421 moves from the first position toward the second position.

The main body 10 may include an accommodating space 13a configured to accommodate the door opening device 400, and an opening 13b provided at one side of the accommodating space 13a. The moving rod 421 may be configured to be withdrawn from the accommodating space 13a through the opening 13b when moving from the first position to the second position, and be inserted into the accommodating space 13a through the opening 13b when moving from the second position to the first position.

The door opening device 400 may further include an opening cover 423 coupled to the one side of the moving rod 421 and configured to cover the opening 13b when the moving rod 421 is located at the first position.

The push roller 422 may be disposed to penetrate the opening cover 423.

The opening cover 423 may be disposed to penetrate through the opening 13b when the moving rod 421 is located at the first position.

The opening cover 423 may include a cover portion 423a configured to cover the opening 13b from outside the accommodating space 13a when the moving rod 421 is located at the first position. The cover portion 423a may extend to cover up to an outer peripheral portion of the opening 13b when the moving rod 421 is located at the first position.

The opening cover 423 may further include an extension portion 423b extending from the cover portion 423a, through the opening 13b, and toward the accommodating space 13a when the moving rod 421 is located at the first position.

The opening cover 423 may be configured to surround a portion of the push roller 422.

The opening cover 423 may include a coupling groove 423d. The moving rod 421 may include a protrusion formed on the one side of the moving rod 421 and inserted into the coupling groove 423d such that the opening cover 423 is fitted thereto.

When the moving rod 421 is located at the first position, at least a portion of the push roller 422 may be located outside the accommodating space 13a.

The push roller 422 may be configured to be rotatable about a rotation axis in a direction parallel to an extension direction of a rotation axis of the door 30.

The push roller 422 may include a roller shaft 422a extending parallel to the extension direction of the rotation axis of the door 30, and the moving rod 421 may include a roller shaft hole 421c formed at one end of the moving rod 421 and into which the roller shaft 422a is insertable.

The moving rod 421 may be configured to be linearly movable relative to the main body 10 between the first position and the second position.

The refrigerator 1 may further include a plate 90 attached to one surface of the door 30 facing the push roller 422 when the door 30 closes the storage compartment 20. When the moving rod 421 moves from the first position to the second position, the push roller 422 may be configured to press the plate 90.

The plate 90 may extend in a direction perpendicular to a rotation axis of the door 30.

A refrigerator 1 according to an embodiment of the disclosure may include a main body 10 forming a storage compartment 20, a door 30 configured to open and close the storage compartment 20, and a door opening device 400 mounted on the main body 10 and configured to open the door 30. The main body 10 may include an accommodating space 13a configured to accommodate the door opening device 400, and an opening 13b provided at one side of the accommodating space 13a. The door opening device 400 may include a drive motor 432, a moving rod 421 configured to receive power from the drive motor 432 and be withdrawn from the accommodating space 13a through the opening 13b or be inserted into the accommodating space 13a through the opening 13b, and a push roller 422 rotatably coupled to one side of the moving rod 421 so as to be rotatable relative to the moving rod 421, the push roller 422 being configured to press the door 30 and rotate relative to the moving rod 421 when the moving rod 421 moves in a direction in which the moving rod 421 is withdrawn from the accommodating space 13a.

The door opening device 400 may further include an opening cover 423 coupled to the one side of the moving rod 421 and configured to cover the opening 13b when the moving rod 421 is located at a position inserted into the accommodating space 13a. The push roller 422 may be disposed to penetrate the opening cover 423.

A refrigerator 1000 according to an embodiment of the disclosure may include a main body 10 forming a storage compartment 20, a door 1030 configured to open and close the storage compartment 20 and having an accommodating space 1030a formed therein and an opening 1030b provided at one side of the accommodating space 1030a, and a door opening device 1040 accommodated in the accommodating space 1030a and configured to open the door 1030. The door opening device 1040 may include a moving lever 1421 configured to be movable relative to the accommodating space 1030a and be withdrawn from the accommodating space 1030a through the opening 1030b or be inserted into the accommodating space 1030a through the opening 1030b, and a push roller 1422 rotatably coupled to one side of the moving lever 1421 so as to be rotatable relative to the moving lever 1421, the push roller 1422 being configured to press the main body 10 and rotate relative to the moving lever 1421 when the moving lever 1421 moves in a direction to be withdrawn from the accommodating space 1030a.

The door opening device 1400 may further include an opening cover 1423 coupled to the one side of the moving lever 1421 and configured to cover the opening 1030b when the moving lever 1421 is inserted into the accommodating space 1030a.

The refrigerator 1000 may further include a plate 1090 attached to one surface of the main body 10 facing the push roller 1422 when the door 1030 closes the storage compartment 20. When the moving lever 1421 is withdrawn from the accommodating space 1030a, the push roller 1422 may be configured to press the plate 1090.

According to the spirit of the disclosure, a refrigerator may include a door opening device including a door pusher or a body pusher, thereby enabling a door to be opened.

According to the spirit of the disclosure, the door pusher or the body pusher included in the door opening device of the refrigerator may include a push roller, thereby reducing friction with a counterpart object and allowing the door to be opened smoothly.

According to the spirit of the disclosure, the door pusher or the body pusher included in the door opening device of the refrigerator may include a push roller, thereby reducing friction with a counterpart object and efficiently preventing occurrence of wear or damage to components.

According to the spirit of the disclosure, a plate may be provided on a counterpart object pressed by the door pusher or the body pusher of the refrigerator, thereby reducing friction with the door pusher or the body pusher.

According to the spirit of the disclosure, the door pusher or the body pusher included in the door opening device of the refrigerator may include an opening cover, thereby efficiently preventing foreign substances from entering components of the refrigerator.

The effects of the disclosure are not limited to those described above, and other effects that are not described above will be clearly understood by those skilled in the art from the above detailed description.

Although the disclosure has been described in detail above with reference to exemplary embodiments, those of ordinary skill in the technical field to which the disclosure pertains should be able to understand that various modifications and alterations may be made without departing from the technical spirit and scope of the disclosure.

1. A refrigerator comprising:
a main body forming a storage compartment;
a door configured to open and close the storage compartment; and
a door opening device, mountable on the main body, configured to open the door,
wherein the door opening device includes:
a moving rod configured to be movable relative to the main body between a first position and a second position; and
a push roller, coupleable to one side of the moving rod, so as to be rotatable relative to the moving rod while being coupled to the one side of the moving rod, the push roller being configured to press the door while being rotated relative to the moving rod as the moving rod moves from the first position toward the second position along a direction in which the door is opened.

2. The refrigerator of claim 1, wherein the main body includes an accommodating space configured to accommodate the door opening device, and an opening at one side of the accommodating space,
wherein the moving rod is configured to be:
withdrawn from the accommodating space through the opening based on the moving rod moving from the first position to the second position, and
inserted into the accommodating space through the opening based on the moving rod moving from the second position to the first position.

3. The refrigerator of claim 2, wherein the door opening device further includes:
an opening cover, coupleable to the one side of the moving rod, configured to cover the opening while the moving rod is located at the first position.

4. The refrigerator of claim 3, wherein the push roller is disposed to penetrate the opening cover.

5. The refrigerator of claim 3, wherein the opening cover is disposed to penetrate through the opening while the moving rod is located at the first position.

6. The refrigerator of claim 3, wherein the opening cover includes:
a cover portion configured to cover the opening from outside the accommodating space while the moving rod is located at the first position,
wherein the cover portion extends to cover up to an outer peripheral portion of the opening while the moving rod is located at the first position.

7. The refrigerator of claim 6, wherein the opening cover further includes:
an extension portion extending from the cover portion, through the opening, and toward the accommodating space while the moving rod is located at the first position.

8. The refrigerator of claim 3, wherein the opening cover is configured to surround a portion of the push roller.

9. The refrigerator of claim 3, wherein the opening cover includes a coupling groove, and the moving rod includes a protrusion formed on the one side of the moving rod and inserted into the coupling groove such that the opening cover is fitted thereto.

10. The refrigerator of claim 2, wherein while the moving rod is located at the first position, at least a portion of the push roller is located outside the accommodating space.

11. The refrigerator of claim 1, wherein the push roller is configured to be rotatable about a rotation axis along a direction parallel to an extension direction of a rotation axis of the door.

12. The refrigerator of claim 11, wherein the push roller includes a roller shaft extending parallel to the extension direction of the rotation axis of the door, and the moving rod includes a roller shaft hole formed at one end of the moving rod and into which the roller shaft is insertable.

13. The refrigerator of claim 1, wherein the moving rod is configured to be linearly movable relative to the main body between the first position and the second position.

14. The refrigerator of claim 1, further comprising:
a plate attached to one surface of the door facing the push roller while the door closes the storage compartment,
wherein as the moving rod moves from the first position to the second position, the push roller is configured to press the plate.

15. The refrigerator of claim 14, wherein the plate extends along a direction perpendicular to a rotation axis of the door.
